(19) United States
(12) Patent Application Publication
(10) Pub. No.: US 2021/0058508 A1
(43) Pub. Date: Feb. 25, 2021

(54) Emergency Network Test Apparatus and Method

(71) Applicant: RapidSOS, Inc., New York, NY (US)

(72) Inventors: Lucas Richard Eager Leavitt, Forest Hills, NY (US); Zvika Ferentz, Rye Brook, NY (US); Palermo Deschamps, New York, NY (US); Ahmed Hassan, Brooklyn, NY (US); Henry Katz, Brookline, MA (US); William Robinson, Bronx, NY (US); Michael John Martin, Long Island, NY (US); Nicholas Edward Horelik, Long Island City, NY (US)

(21) Appl. No.: 16/999,038

(22) Filed: Aug. 20, 2020

Related U.S. Application Data
(60) Provisional application No. 62/889,038, filed on Aug. 20, 2019.

(51) Int. Cl. H04M 3/26; H04M 3/24; H04M 3/51

(52) U.S. Cl. CPC H04M 3/26; H04M 3/242; H04M 3/5116; H04M 2242/14; H04M 2203/056; H04M 2242/30; H04M 2201/42

(57) ABSTRACT

A method of testing an emergency network, includes: simulating, by test logic, a public emergency network entity and a plurality of interfaces between the public emergency network entity and a test device; monitoring, by the test logic, the plurality of interfaces to determine that data flowed correctly on each interface in response to an emergency alert sent from the test device such that the emergency alert is not actually sent to the public emergency network entity; and determining, by the test logic, a test status for each interface indicating a success or failure of a test, for each interface, the test status based on data correctness such that the test confirms that the emergency alert and associated emergency data would be sent to the public emergency network entity correctly.

### CROSS-REFERENCE TO RELATED APPLICATIONS

The present application claims priority to U.S. Provisional Patent Application No. 62/889,038, filed Aug. 20, 2019, entitled “EMERGENCY TEST APPARATUS AND METHOD” which is hereby incorporated by reference herein in its entirety, and which is assigned to the same assignee as the present application.

### FIELD OF THE DISCLOSURE

The present disclosure relates generally to emergency calls, next generation E911 emergency call systems, and more particularly to apparatuses and methods for testing data and voice services to emergency networks.

### BACKGROUND

Emergency networks such as, but not limited to, public safety answering points (PSAPs), utilize various emergency services network architectures which provide interconnection between the Internet protocol (IP) domain, E911 infrastructure or other emergency network infrastructure.

An “emergency network” includes various emergency network entities that receive emergency calls and possibly emergency alerts, depending on their respective capabilities, and coordinate emergency assistance. An emergency network may be owned and operated by a public organization run by a municipality, county or city, or may be a private organization. Emergency assistance provided can include medical, caregivers, firefighting, police, military, paramilitary, border patrol, lifeguard, security services, or any combination thereof. A “public-safety answering point” (PSAP) refers to one type of an emergency network with authoritative jurisdiction to answer calls to emergency numbers for police, firefighting, ambulance services, etc.

The IP domain in emergency network architectures includes various private and public server providers, and call control interfaces in the IP domain may be Session Initiation Protocol (SIP), H.323, or some other suitable protocol that can meet National Emergency Number Association (NENA) requirements as well as provide required call control functionality. Various logical signaling interfaces, such as SIP signaling interfaces, are used in the network architecture for exchanging location related data in the IP domain.

The Public Switched Telephone Network (PSTN) in the circuit switched domain interfaces directly with the emergency networks such as PSAPs. On the circuit switched side, an Automatic Location Identification (ALI) database provides a PSAP with a caller's address or geodetic (XY) location of the telephone and also supplementary emergency service information related to the location of call origination. Non-emergency calls can be sent between the PSTN and the IP domain via a PSTN gateway which interfaces with one or more routing proxy servers and corresponding redirect servers.

Provision of emergency service access for the IP domain, involves E911 selective routers operating in conjunction with a Selective Routing Database (SRDB) which is the routing table relating telephone numbers to Emergency Service Numbers (ESNs) and which determines the routing of 911 calls. The E911 selective routers interface with one or more Emergency Services Gateways (ESGW) which provide a signaling and media interface between the circuit switched conventional E911 SRDB and the IP domain.

In the IP domain, various logical signaling interfaces are utilized, such as an interface for forwarding calls via a routing proxy server, or call server, to the correct ESGW. Multiple logical signaling interfaces are related to location information which is or course, critical information. For example, voice-over-Internet protocol (VoIP) end points may receive pre-determined location information from a Location Information Server (LIS) over one of the logical signaling interfaces. The LIS may serve as a location information repository with either geo-spatial location data or civic address data, correlated to physical locations, and may also include a “wiremap,” that is, mappings between individual location information and logical representations of the physical locations. A VoIP Positioning Center (VPC) may provide routing information for VoIP emergency calls and helps deliver location information to a PSAP using the ALI infrastructure using the industry standard E2 Interface.

In any event, determining whether these various logical signaling interfaces are working properly, and whether location information in the IP domain or for mobile device emergency calls are being properly received can be difficult to test and often the only way to test this connectivity is by having a technician present on site of an emergency network.

### BRIEF DESCRIPTION OF THE DRAWINGS

FIG. 1 is a block diagram showing an emergency network, such as a public safety answering point (PSAP), and a private emergency network entity, such as a central station, and in which the emergency network has various service integrations.

FIG. 2 is a block diagram of connections and interfaces between an emergency network such as a PSAP, and E911 infrastructure and test logic in accordance with the embodiments.

FIG. 3 is a block diagram showing example details of test logic in accordance with some embodiments.

FIG. 4 is a diagram of a graphical user interface (GUI) feature related to test logic in accordance with an embodiment.

FIG. 5 is a message flow diagram showing a method of operation of the test logic in accordance with various embodiments.

FIG. 6 is a flowchart showing a method of operation of the test logic in accordance with various embodiments.

FIG. 7 is a diagram of a graphical user interface (GUI) feature related to test logic in accordance with an embodiment.

FIG. 8 is a diagram of a graphical user interface (GUI) feature related to test logic in accordance with an embodiment.

FIG. 9 is a diagram of a graphical user interface (GUI) feature related to test logic in accordance with an embodiment.

FIG. 10 is a diagram of a graphical user interface (GUI) feature related to test logic in accordance with an embodiment.

FIG. 11 is a diagram of a graphical user interface (GUI) feature related to test logic in accordance with an embodiment.

FIG. 12 is another diagram of a graphical user interface (GUI) feature related to test logic in accordance with an embodiment.

FIG. 13 is a diagram of a graphical user interface (GUI) displayed on an emergency network entity display in accordance with an embodiment.

FIG. 14 is a diagram of a graphical user interface (GUI) feature related to test logic in accordance with an embodiment.

FIG. 15 is a diagram of a graphical user interface (GUI) displayed on a device display in accordance with an embodiment.

FIG. 16 is a diagram of a graphical user interface (GUI) displayed on a device display in accordance with an embodiment.

FIG. 17 is a diagram of a graphical user interface (GUI) displayed on a device display in accordance with an embodiment.

FIG. 18 is a diagram of a graphical user interface (GUI) displayed on a device display in accordance with an embodiment.

FIG. 19 is a diagram of a graphical user interface (GUI) displayed on a device display in accordance with an embodiment.

FIG. 20 is a flowchart showing a method of operation of the test logic in accordance with various embodiments.

FIG. 21 is a flowchart showing a method of operation of the test logic in accordance with various embodiments.

FIG. 22 is a flowchart showing a method of operation of the test logic in accordance with various embodiments.

### DETAILED DESCRIPTION

Briefly, the present disclosure provides an apparatus that is operative to test service integrations operating on an emergency network entity, and to initiate an automated emergency test call to test location information reception as well as other supplemental emergency service integration information. Among other advantages, the present disclosure provides testing tools for testing data and voice connections to an emergency network. The apparatus is also operative to simulate a public emergency network entity such that interfaces and data flows to the public emergency network entity can be tested in a non-disruptive manner without interrupting service of the actual public emergency network entity such as a call handling workstation handling 9-1-1 emergency calls.

The present disclosure provides a method that includes simulating, by test logic, a public emergency network entity and a plurality of interfaces between the public emergency network entity and a test device; monitoring, by the test logic, the plurality of interfaces to determine that data flowed correctly on each interface in response to an emergency alert sent from the test device such that the emergency alert is not actually sent to the public emergency network entity; and determining, by the test logic, a test status for each interface indicating a success or failure of the test for each interface, the test status based on data correctness such that the test confirms that the emergency alert and associated emergency data would be sent to the public emergency network entity correctly.

The method may further include receiving the emergency alert sent from an alarm system where the alarm system is the test device. The method may further include receiving the emergency alert at a private emergency network entity that is performing a test on behalf of the public emergency network entity. The method may further include performing a geofence analysis of a location associated with the test device; and executing the test only if the location is determined to be within a geofence associated with the public emergency network entity. The method may further include performing a geofence analysis of a location associated with the test device; and preventing execution of the test if the location is determined to be outside a geofence associated with the public emergency network entity. The method may further include providing a simulated private emergency network entity graphical use interface (GUI) on a public emergency network entity; and displaying an alert queue having an entry for the emergency alert as it would appear if sent to the public emergency network entity. The method may further include initiating, by the test logic, an emergency phone call from the test device, the test device having a location within a geofence of the public emergency network entity. Initiating an emergency phone call from a test device, may include initiating, by the test logic, an emergency phone call as one of a voice-over-IP (VoIP) application phone call or a managed VoIP services phone call. The method may further include initiating, by the test logic, an emergency short-message-service (SMS) text message from the test device, where the test device has a location within a call routing boundary of the public emergency network entity. The method may further include initiating, by the test logic, an emergency Internet Protocol Instant Message (IM) message from the test device, where the test device has a location within a call routing boundary of the public emergency network entity. The method may further include sending, by the test logic, a plurality of representational state transfer (RESTful) hyper-text-transfer-protocol (HTTP) requests to a plurality of associated emergency network entities over the plurality of interfaces. The method may further include querying a Location Information Server (LIS) to obtain location information; querying an Automatic Location Identification (ALI) database to obtain location information; querying a Standard Master Street Address Guide (MSAG) to obtain location information; or querying an Emergency Services Zone Routing Database (ERDB) to verify that a location is within an emergency network call routing boundary.

The present disclosure provides an emergency network test logic that includes an emergency network entity simulator, operative to simulate a public emergency network entity and a plurality of interfaces between the public emergency network entity and a test device; and manager logic, operatively coupled to the network entity simulator. The manager logic is operative to: monitor the plurality of interfaces to determine that data flowed correctly on each interface in response to an emergency alert sent from the test device such that the emergency alert is not actually sent to the public emergency network entity; and determine a test status for each interface indicating a success or failure of the test for each interface. The test status is based on data correctness such that the test confirms that the emergency alert and associated emergency data would be sent to the public emergency network entity correctly.

The present disclosure provides a method of testing an emergency network such as, but not limited to, a public safety answering point (PSAP), which includes: simulating, by test logic, a plurality of service integrations executing on an emergency network entity by running queries associated with each service integration; monitoring, by the test logic, the queries to determine that a response was received for each query; verifying, by the test logic, that each response received includes correct data; determining, by the test logic, a test status for each service integration indicating a success or failure of the test for each service integration, the test status based on receipt of a response for all queries associated with a specific service integration and based on data correctness; and providing, by the test logic, a diagnostic error code for any service integration with a fail test status. The method may further include initiating, by the test logic, an emergency phone call from a test device, the test device having a location within a call routing boundary of the emergency network. The emergency phone call from a test device may be implemented as a voice-over-IP (VoIP) application phone call or a managed VoIP services phone call.

The method may further include initiating, by the test logic, an emergency short-message-service (SMS) text message from a test device, where the test device has a location within a call routing boundary of the emergency network. The method may further include initiating, by the test logic, an emergency Internet Protocol Instant Message (IM) message from a test device, where the test device has a location within a call routing boundary of the emergency network.

Running queries may include sending, by the test logic, a plurality of representational state transfer (RESTful) hyper-text-transfer-protocol (HTTP) requests to a plurality of associated emergency service integration entities, where each emergency service integration entity corresponds to a service integration; and sending, by the test logic, a plurality of requests to other emergency services network entities using an appropriate protocol for each emergency services network entity. For example, the requests to other emergency services network entities may include querying a Location Information Server (LIS) to obtain location information; querying an Automatic Location Identification (ALI) database to obtain location information; querying a Standard Master Street Address Guide (MSAG) to obtain location information; and querying an Emergency Services Zone Routing Database (ERDB) to verify that a location is within an emergency network call routing boundary.

The present disclosure also provides a method of emergency testing, which includes: identifying an emergency network entity, wherein the emergency network entity is associated with a geofence; obtaining a test location falling within the geofence; simulating an emergency alert from the electronic device; monitoring for a receipt of the emergency alert at the emergency network entity; and determining a test status for the emergency alert, wherein the test status comprises a response message, the response message comprising an error code for a test status of failure. The method may further include identifying an electronic device proximal to the test location.

The present disclosure also provides emergency network test logic, which includes manager logic. The manager logic is operative to: simulate a plurality of service integrations executing on an emergency network entity by running queries associated with each service integration; monitor the queries to determine that a response was received for each query; verify that each response received includes correct data; determine a test status for each service integration indicating a success or failure of the test for each service integration where the test status is based on receipt of a response for all queries associated with a specific service integration and based on data correctness; and provide a diagnostic error code for any service integration with a fail test status. The test logic may further include call flow logic, operatively coupled to the manager logic, where the manager logic is further operative to initiate an emergency phone call from a test device using the call flow logic, with the test device having a location within a call routing boundary of the emergency network. The manager logic is operative to initiate an emergency phone call as one of a voice-over-IP (VoIP) application phone call or a managed VoIP services phone call. The manager logic may be further operative to initiate an emergency short-message-service (SMS) text message from a test device, where the test device has a location within a call routing boundary of the emergency network. The manager logic may be further operative to initiate an emergency Internet Protocol Instant Message (IM) message from a test device, where the test device has a location within a call routing boundary of the emergency network.

The manager logic may be further operative to: send a plurality of representational state transfer (RESTful) hyper-text-transfer-protocol (HTTP) requests to a plurality of associated emergency service integration entities, where each emergency service integration entity corresponds to a service integration; and send a plurality of requests to other emergency services network entities using an appropriate protocol for each of the emergency services network entities.

The manager logic may be further operative to send a plurality of requests to other emergency services network entities using an appropriate protocol for each emergency services network entity by: querying a Location Information Server (LIS) to obtain location information; querying an Automatic Location Identification (ALI) database to obtain location information; querying a Standard Master Street Address Guide (MSAG) to obtain location information; and querying a Emergency Services Zone Routing Database (ERDB) to verify that a location is within an emergency network call routing boundary.

The emergency network test logic may include front end logic, operatively coupled to the manager logic. The front end logic is operative to provide a graphical user interface (GUI) that displays a list of service integrations active for the emergency network.

The present disclosure also provides emergency network test logic, that includes front end logic, operative to provide a graphical user interface (GUI) operative to display a list of service integrations active for the emergency network, and operative to receive an input to initiate an emergency test call to the emergency network; manager logic, operatively coupled to the front end logic, where the manager logic is operative to provide an asynchronous microservice that accepts Representational State Transfer (RESTful) HTTP requests, and to set up and trigger emergency network system tests in response to GUI input received from the front end logic; and call flow logic, operatively coupled to the manager logic, operative to initiate an emergency call by a test device in response to commands received from the manager logic.

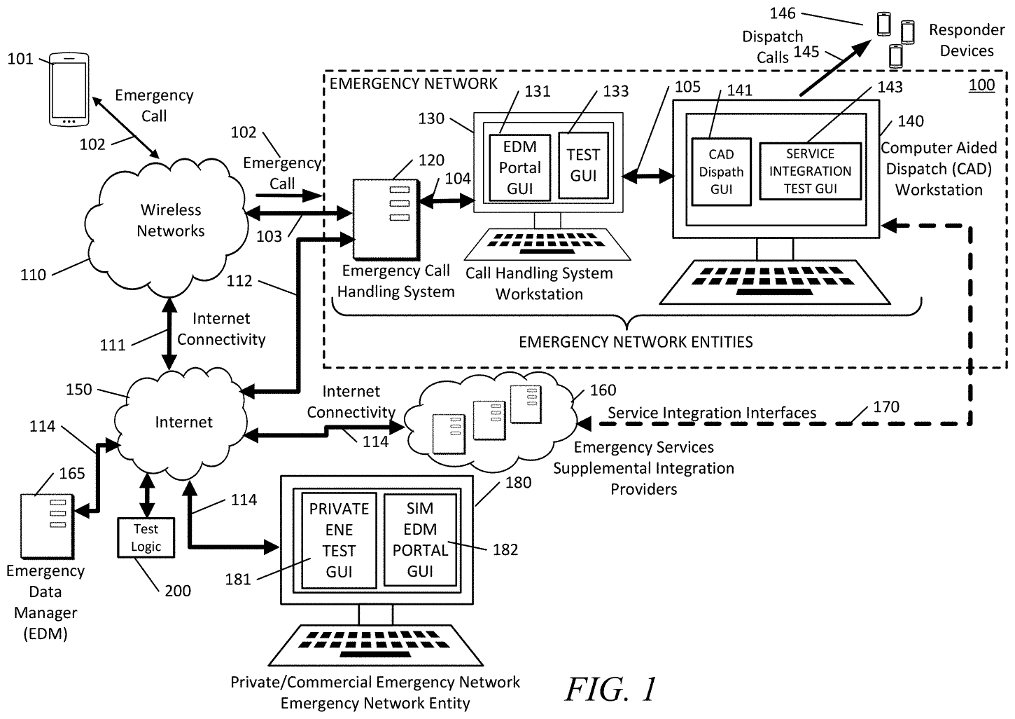

Turning now to the drawings wherein like numerals represent like components, FIG. 1 illustrates an emergency network 100 such as, but not limited to, a public safety answering point (PSAP). The emergency network includes various emergency network entities such as an emergency call handling system 120, a call handling system workstation 130 and a computer aided dispatch (CAD) workstation 140. The emergency call handling system 120 is operatively coupled to a PSTN (public switched telephone network) and various wireless networks 110 via a backhaul connection 103. The emergency call handling system 120 is operative to receive an emergency call 102, for example, from a mobile device 101 that is operatively coupled wirelessly to one of the various wireless networks 110 as well as emergency calls from landline phones connected to the PSTN. The emergency call handling system 120 is further operatively coupled via a connection 104, which may be an Ethernet connection, to a call handling system workstation 130, at which emergency network personnel may receive the emergency call 102 and speak with the caller if possible. However, depending upon the nature of the emergency, the caller may not be able to speak due to injuries, or other exigent circumstances. One of the emergency network entities, such as the call handling system workstation 130 or the CAD workstation 140 may receive emergency alerts, which are not emergency calls, by way of an emergency data manager (EDM) portal GUI 131 that is provided by an emergency data manager 165. The emergency data manager 165 operates remotely from the emergency network 100 and provides at least one software-as-a-service (SaaS) application to various emergency networks. The SaaS application is accessible by emergency network personnel via an EDM portal GUI 131. Emergency alerts may be sent directly to the emergency network 100 and/or to the emergency data manager 165, from various devices such as, but not limited to, mobile phones, sensors, IoT connected devices, IoT connected device hubs, wearables, connected vehicle systems, connected panic buttons, etc. The emergency alerts that are sent from devices to the emergency data manager 165 are pushed to an emergency network EDM portal GUI 131, and the emergency data manager 165 may provide additional related emergency data to the emergency network 100. The call handling system workstation 130 includes a display operative to provide one or more graphical user interfaces (GUIs) related to emergency response applications. For example, one GUI 132 may be related to an emergency response application for managing emergency alerts and GUI 133 may be related to emergency network test logic in accordance with the present disclosure. The call handling system workstation 130 is further operatively coupled to a computer aided dispatch (CAD) system 140 via a connection 105, which may also be an Ethernet connection. The CAD system 140 includes one or more processors that are operative to execute one or more emergency network related applications. The CAD system 140 includes a display operative to provide one or more graphical user interfaces (GUIs) 141 related to the emergency network related applications. For example, one GUI 142 may be related to a location emergency services application or emergency response application and GUI 143 may be related to emergency network test logic in accordance with the present disclosure. Emergency network personnel may receive appropriate emergency services information via the GUI 142 and other GUIs, and place dispatch calls 145 to emergency responders 146 accordingly. Emergency services test information may be viewed via GUI 143 and emergency services tests may also be initiated from GUI 143. The GUI 142 and GUI 143, as well as other GUIs, may each be provided as a web browser interface (such as a cloud-based application interface), or via a web browser plug-in, or may be associated with applications running on the machine on which they are displayed, or by any other software implementation mechanism.

The various wireless networks 110 are operatively coupled to the Internet 150 via Internet connectivity 111 and provide Internet connections to the various mobile devices, such as mobile device 101, that are connected to the various wireless networks 110. The emergency call handling system 120 is also connected to the Internet 150 via Internet connectivity 112.

A private or commercial emergency network includes an emergency network entity 180 which has an Internet connection may thus be operatively coupled to the emergency network 100 and to one or more emergency network entities such as the call handling system workstation 130 and the CAD system 140. An example private or commercial emergency network is a home security or business security service provider network or an alarm dealer network owned and operated by an alarm dealer that provides home and business alarm systems and support. In the alarm and security services industry, an emergency network entity such as emergency network entity 180 is referred to as a “central station.” A central station receives signals from alarm systems and an operator makes decisions on when to contact a public emergency network, such as by calling 9-1-1, so that police, fire, ambulance, etc. depending on the type of emergency, may be dispatched by the public emergency network to the location from which an alarm was received. The emergency network 100 is an example of a public emergency network. The emergency data manager 165 is operatively coupled to the emergency network entity 180 via an Internet connection and may provide alarm data and other emergency data to the emergency network entity 180. The emergency data manager 165 is operative to receive emergency data from various sources including, but not limited to, mobile devices such as mobile device 101, the wireless networks 110 and other sources such as sensors, IoT connected devices, IoT connected device hubs, wearables, connected vehicle systems, connected panic buttons, and various alarm systems, etc.

The emergency network entity 180 may be operatively coupled to the call handling system 120, the call handling system workstation 130, or the CAD system 140 via the Internet 150 and Internet connectivity 114. When the emergency network entity 180 serves in the role of central station is acts as an intermediary between a data source including alarm systems and an emergency network. The emergency network entity 180 includes a display and one or more processors that are operative to execute one or more emergency services related applications and a web browser to access a private emergency network entity test GUI 181 provided by test logic 200. The emergency network entity 180 may execute and display a GUI for an alarm management application. The emergency network entity 180 may also be operatively coupled to the emergency data manager 165 to receive emergency data stored from various data sources.

Various emergency service supplemental integration providers 160 are operatively coupled to the emergency network and the CAD system 140 via the Internet 150 and Internet connectivity 114. Each of the various emergency service supplemental integration providers 160 are operative to receive data from various data sources including, but not limited to, mobile devices such as mobile device 101, the wireless networks 110 and other sources, etc. The received data includes, but is not limited to, location information such as Location-by-Reference, Location-by-Value, etc. from, for example a, Location Information Server (LIS) or from other sources.

Each of the various emergency service supplemental integration providers 160 are operative to send data to the CAD system 140 via the Internet 150 and Internet connectivity 112 to the emergency network, and provide corresponding service integrations 170 which may provide individual GUIs related to the service, or may provide some mechanism to provide information within a GUI of some other service or application. In other words, the various emergency service supplemental integration providers 160 provide service integrations 170 via software applications that may run on the call handling system workstation 130, the CAD system 140 or both, or via web browser interfaces (such as cloud-based application interfaces), or via a web browser plug-in, etc., or combinations thereof, that may likewise run on the call handling system workstation 130, the CAD system 140 or both.

Test logic 200 is operatively coupled to the emergency network 100, the emergency data manager 165, and the emergency network entity 180 via the Internet 150 and Internet connectivity 114. The test logic 200 is operative to initiate emergency tests from various devices, as described below. The test logic 200 may be integrated with, or otherwise provided by the emergency data manager 165 in some implementations. The test logic 200 may include applications such as a mobile application and provides various testing GUIs such as the service integration GUI 143 on a CAD workstation 140, a test GUI 133 on a call handling system workstation 130, and a private emergency network entity test GUI 181 on the emergency network entity 180. The test logic 200 may provide all of these GUIs as web browser accessible GUIs such that there is an SaaS application interface to the test logic 200. The test logic 200 is operative to simulate end points and/or certain emergency network entities, to facilitate testing of critical emergency network entity interfaces without causing disruption to the daily emergency network operations. For example, emergency networks such as PSAPs are mostly unable to disrupt 911 call capabilities with testing procedures. The test logic 200 provides capabilities to perform non-disruptive testing of emergency networks such as PSAPs by simulating portions of the emergency network thereby preventing operational disruption of E911 services.

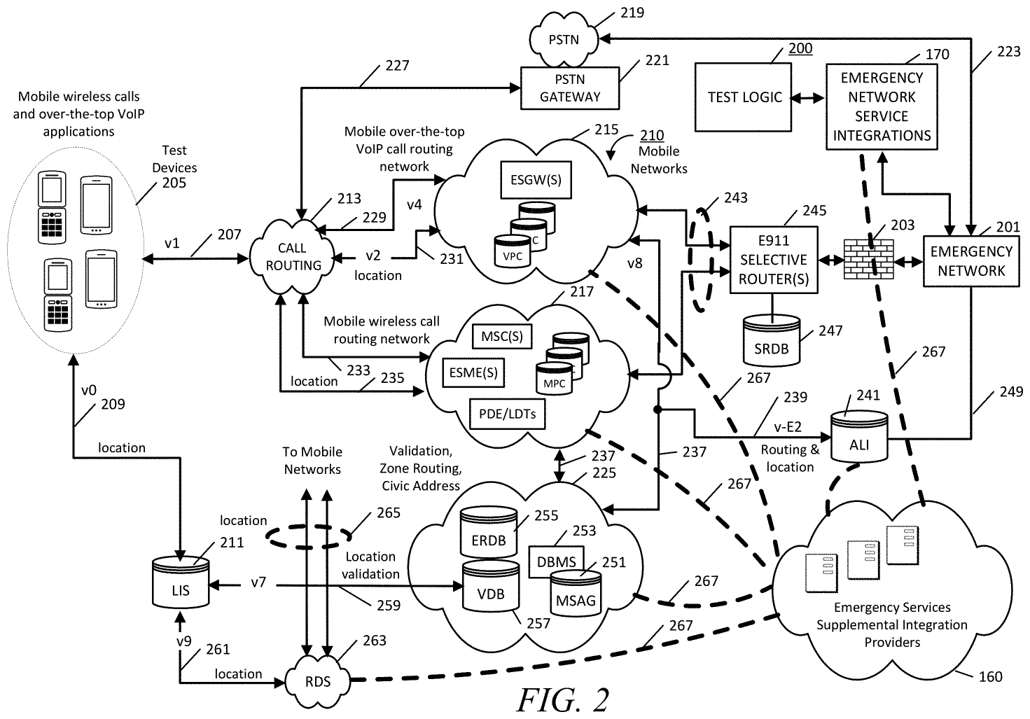

FIG. 2 is a network block diagram showing E911 system architecture and infrastructure and provides details on the various data sources from which the various emergency service supplemental integration providers 160 may obtain data. FIG. 2 also provides an example of the various emergency services network entities within an E911 system architecture which may communicate with the emergency network 201. It is to be understood that the E911 system architecture and infrastructure shown in FIG. 2 is an example only and that actual architectures and infrastructures may vary with respect to how calls are routed through the system and how location information is promulgated.

Emergency calls can be provided to the emergency network 201 via various mobile networks 210 which include a VoIP call routing network 215 and a mobile wireless call routing network 217. Each of these may enable IP domain call functionality. Call control interfaces in the IP domain may be Session Initiation Protocol (SIP), H.323, or some other suitable protocol that can meet the National Emergency Number Association (NENA) requirements and provide the necessary call control functionality required for emergency calls. The Public Switched Telephone Network (PSTN) 219 in the circuit switched domain interfaces directly with the emergency network 201 via emergency call interface 223 which may be, for example, an SS7 interface. On the circuit switched side, an Automatic Location Identification (ALI) database 241 operatively coupled to the emergency network 201 by an ALI feed 249, provides the emergency network 201 with a caller's address or geodetic (XY) location of the telephone and also supplementary emergency service information related to the location of call origination. Non-emergency calls can be sent between the PSTN 219 and the IP domain via a PSTN gateway 221 which interfaces with one or more routing proxies and corresponding redirect servers within a call routing network 213. The call routing network 213 is operative to route calls through the PSTN 219 via PSTN gateway data connection 227.

Emergency service access may be provided for the IP domain, by E911 selective routers 245 that operate in conjunction with a Selective Routing Database (SRDB) 247 which is the routing table relating telephone numbers to Emergency Service Numbers (ESNs) and which determines the routing of 911 calls. The E911 selective routers 245 utilize interfaces 243 to communicate with one or more Emergency Services Gateways (ESGW) within the VoIP call routing network 215 which provide a signaling and media interface between the circuit switched conventional E911 SRDB 247 and the IP domain. Various MSCs within the mobile wireless call routing network 217 may interface with the PSTN 219 directly via SS7/C7 interfaces, however the emergency network 201 may obtain location information or other information from MPCs over the interfaces 243 via the Internet. A firewall 203 is incorporated into the emergency network 201 to provide protection against intrusion in the IP domain.

Various logical signaling interfaces are used in the IP domain for call routing and these interfaces are specified by NENA. For example, a VoIP call routing interface 229, such as the v4 interface, is for forwarding calls via a routing proxy or call server/proxy within the call routing network 213 to the correct ESGW within the VoIP call routing network 215. Other interfaces not shown in FIG. 2 include the v5 interface which is defined as a SIP interface between a call server/proxy and one or more redirect servers within the call routing network 213; while the v6 interface is defined as a SIP interface between a call server/proxy and a routing proxy. A set of test devices 205 may operate to make wireless mobile calls or may function as a VoIP end point, such as a VoIP telephone, to communicate with a call server/proxy via, for example, the v1 call routing interface 207.

In the IP domain, various logical interfaces are related to location information such as “v0,” “v2,” “v3,” “v7,” “v8,” and “v9”. For example, a test device 205 acting as a VoIP end point may receive pre-determined location information from a Location Information Server (LIS) 211 over the v0 location data interface 209. The LIS 211 may serve as a location information repository with either geo-spatial location data or civic address data, correlated to physical locations. The LIS 211 may also include a “wiremap,” that is, mappings between individual location information and logical representations of the physical locations. Various VoIP Positioning Centers (VPC) within the VoIP call routing network 215 provide routing information for VoIP emergency calls and help deliver location information to the emergency network 201 via the ALI 241 infrastructure using a routing and location interface 239, for example the v-E2 interface. Call server/proxies within the call routing network 213 use a VoIP location data interface 231, for example the v2 interface, to request emergency call routing information from a VPC within the VoIP call routing network 215 in architectures where the call server/proxy and/or the routing proxy and redirect servers are separate elements from the VPC.

In some implementations, an optional defined interface, the v3 interface (not shown), allows a VPC to obtain an emergency caller's location from the LIS 211. A location validation interface 259, for example the v7 interface, between the LIS 211 and the Validation Database (VDB) 257 within a validation network 225, is used by the LIS 211 to request validation of a specific civic location. The VDB 257 checks the civic location, received in the request, in the Standard Master Street Address Guide (MSAG) 251. A database management system (DBMS) 253 interacts with the MSAG 251, the VDB 257 and an Emergency Services Zone Routing Database (ERDB) 255. The VPCs within the VoIP call routing network 215 may query the ERDB 255 using a location and routing validation interface 237, for example the v8 interface, and obtain routing information and other information for an emergency caller. A location data interface 261, for example the v9 interface, enables the LIS 211 or a VPC to discover the appropriate VDB/ERDB via a Root Discovery Server (RDS) 263. The RDS 263 may communicate with the VoIP call routing network 215 and the mobile wireless call routing network 217 via location data interfaces 265.

Non-VoIP mobile wireless calls are promulgated through the mobile wireless call routing network 217 via a mobile wireless call routing interface 233 and a mobile wireless location data interface 235. In other words, circuit switched 911 access is provided using a traditional circuit switched wireless technology for voice calls such as GSM, UMTS, and CDMA, however such technologies may also be used for managed VoIP services specified by the wireless operator for voice calling on an LTE network, for example. The mobile wireless call routing network 217 includes network entities such as a mobile switching center (MSC), Emergency Services Message Entity (ESME), Positioning Determining Entities (PDE), Location Determination Technology (LDT), and Mobile Positioning Centers/Gateway Mobile Location Center (MPC or MPC/GMLC).

An ESME routes and processes out-of-band messages related to emergency calls, and the functionality may be incorporated into selective routers (also known as Routing, Bridging and Transfer switches) and ALI 241 database engines. A PDE determines a precise position or geographic location (i.e. x and y coordinates) of a mobile device (such as one of the test devices 205) when the device either initiates a call or while it is engaged in a call. The acronym “PDE” is also used to refer to Location Determination Technology (LDT) and therefore the acronyms “PDE” and “LDT” are synonymous.

An MPC or MPC/GMLC is a network entity that interfaces with a PDE/LDT for initial and updated position determination, and that provides an interface between the mobile wireless network and the emergency network. The MPC retrieves, forwards, stores and controls position data within the location services network with restricted access such that position information is provided only while an emergency call is active.

The emergency network 201 includes various emergency network service integrations 170 which are operative to communicate with the one or more emergency services supplemental integration providers 160. The emergency services supplemental integration providers 160 are operative to communicate with various network entities via data connections 267 such as, but not limited to, ALI database 241, RDS 263, LIS 211, ERDB 255, VDB 257, MSAG 251, VPCs, and MPCs, etc. The test logic 200 is operatively coupled to the emergency network service integrations 170 and to the emergency network 201 and is thus operative to test interfaces between the emergency network 201 and the emergency services supplemental integration providers 160. The emergency data manager 165 shown in FIG. 1 also provides interfaces to the emergency network 203 and the test logic 200 is operative to test these interfaces as well.

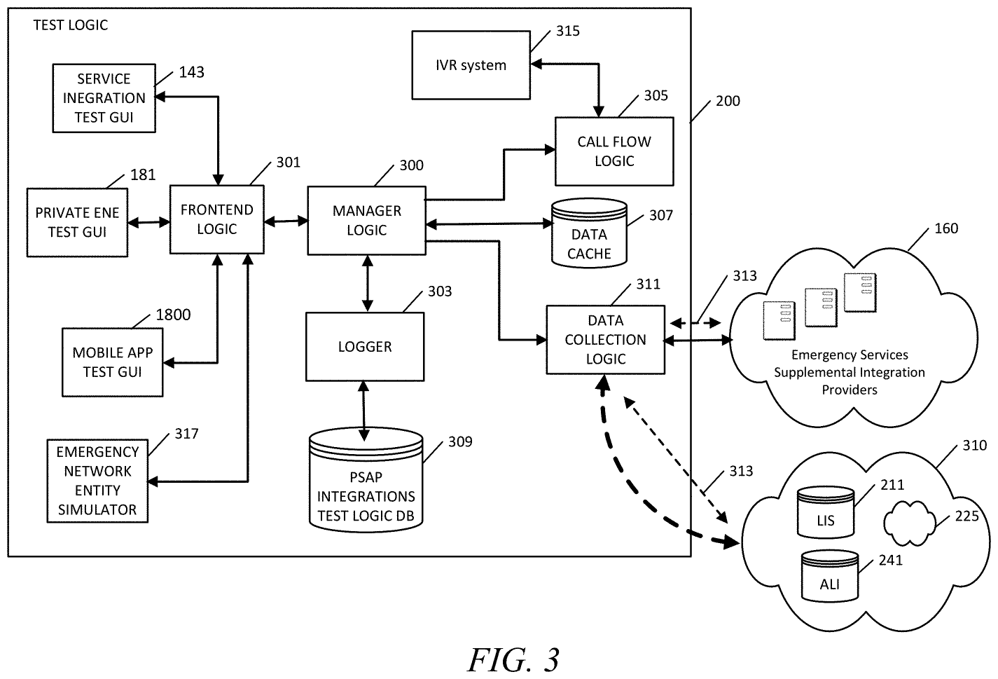

The test logic 200 is operative to simulate the application programming interfaces (APIs) or the various emergency network service integrations 170 in order to test that the connectivity is working properly, and is also operative to initiate an emergency test call using one of the test devices 205. FIG. 3 provides further details of the test logic 200 in accordance with an embodiment.

In FIG. 3, the example test logic 200 provides various testing capabilities and SaaS access to front end logic 301 via various web browser accessible graphical user interfaces (GUIs) such as those shown in FIG. 1, including the service integration test GUI 143, the test GUI 133, the private emergency network entity test GUI 181 and a mobile application test GUI 1800. The front end logic 301 is operatively coupled to other components including manager logic 300, test data logger 303, call flow logic 305, data cache 307 which is a non-volatile, non-transitory memory component, test logic database 309 which is non-volatile, non-transitory memory component, data collection logic 311, an interactive voice response (IVR) system 315 and an emergency network entity simulator 317.

The term “logic” as used herein refers to systems which may be implemented as software or firmware (or as a combination of software and firmware) executing on one or more processors, and may also include, or may be implemented independently, using hardware such as, but not limited to, ASICs (application specific integrated circuits), DSPs (digital signal processors), hardwired circuitry (logic circuitry), or combinations thereof. That is, any of the logic disclosed herein may be implemented using an ASIC, DSP, executable instructions executing on a processor, logic circuitry, or combinations thereof. In other words, the logic may be implemented as hardware, software or by combinations thereof. Therefore, each of the logic components disclosed herein may be considered a type of apparatus that may be implemented and operate independently from the other components in the system. Applications and user interfaces are provided as software-as-a-service (SaaS) graphical user interfaces (GUIs) that are accessible by various emergency network entities using a web browser.

In the example of FIG. 3, the various operatively coupled components of the test logic 200 may be implemented as executable instructions stored in a non-volatile, non-transitory memory which can be executed by one or more processors resident on, for example, the call handling system workstation 130, the CAD system 140 or both, or on a remote server operatively coupled to the call handling system workstation 130, the CAD system 140 or both, or on the emergency network entity 180 which may serve as a central station, where all of these emergency network entities have a non-volatile, non-transitory memory available to the one or more processors.

As used herein, components may be “operatively coupled” when information can be sent between two such components, even though there may be one or more intermediate or intervening components between, or along the connection path. Therefore, any of the various components with the test logic 200 may be understood herein to be operatively coupled to each other where appropriate, and to be executing on one or more processors that are further operatively coupled to a non-volatile, non-transitory memory that stores executable instructions (also referred to as “software code” or “code”) for implementing the various components. Operative coupling may also exist between engines, system interfaces or components implemented as software or firmware executing on a processor and such “software coupling” may be implemented using libraries (i.e. application programming interfaces (APIs)) or other software interfacing techniques as appropriate. Such libraries or APIs provide operative coupling between various software implemented components of FIG. 3.

The test logic 200 supports RESTful (i.e. Representational State Transfer) Web services (RWS) and is operative to send and receive RESTful HTTP requests 313 to and from manager logic 300 between the various emergency service supplemental integration providers 160 as well as other data sources 310 such as, but not limited to, ALI database 241, RDS 263, LIS 211, validation network 225 entities such as ERDB 255, VDB 257, and MSAG 251, as well as VPCs, and MPCs, etc. The test logic 200 is operative to determine and validate test parameters such as, but not limited to location, phone-number, etc., can post location of a phone and can call 9-1-1 by trigger a call/voice flow to interact with 9-1-1 call-takers (via an Emergency-API). The test logic 200 listens (i.e. consumes) different system events (e.g. LEI/LIS requests and logs all manager logic 300 messages and results for later analysis and troubleshooting.

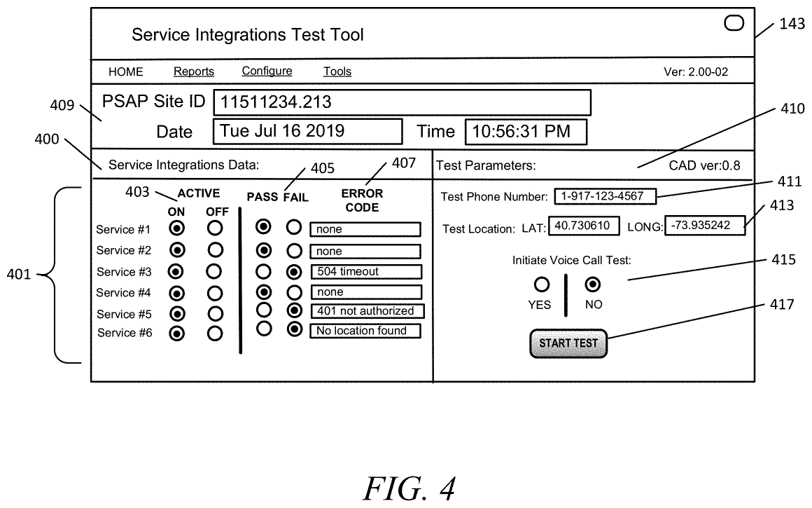

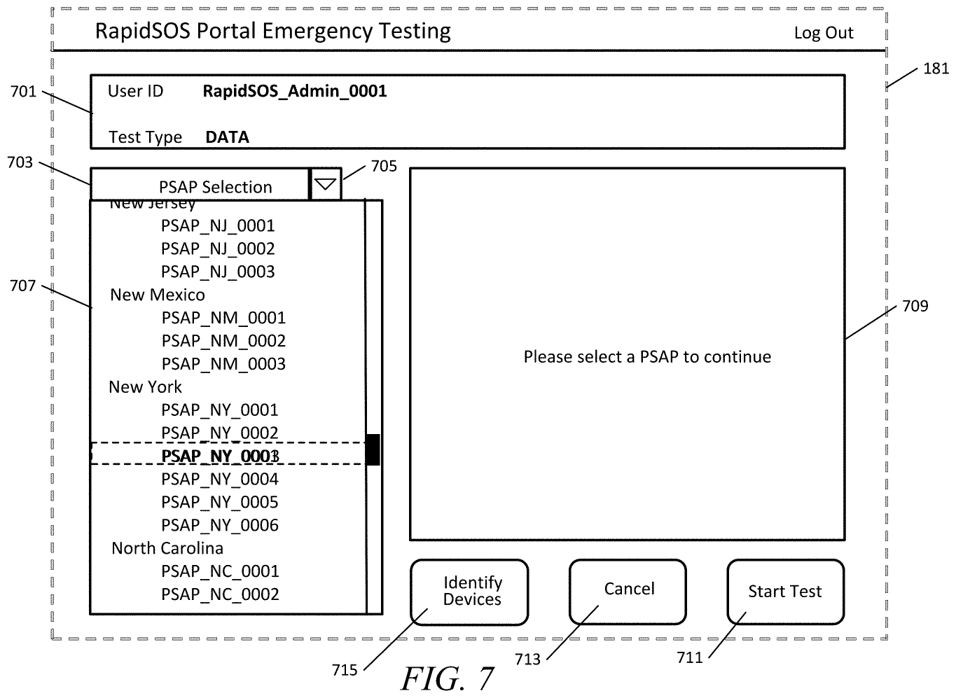

In one example implementation, the manager logic 300 is an asynchronous microservice that accepts HTTP requests, and also sets up and triggers system tests. The test data logger 303 is a microservice that handles logs and test-results and stores them in the test logic database 309, which is a relational database. The frontend logic 301 provides testing interfaces to various emergency network entities and mobile devices to enable running and managing system tests. For example, the service integration test GUI 143 displays, among other things, a list of all integrations that are currently active for an emergency network as shown in FIG. 4. Other test GUI features and operations are described in further detail with respect to FIG. 7 through FIG. 19. The test logic 200 is operative to verify network connectivity and valid credential access to all API (application programming interface) services that each emergency services supplemental integration provider 160 uses on a per integration basis. The results of the tests are communicated to the emergency network operator/user via one of the test GUIs depending upon the specific test type being performed. For example, a in the service integration test GUI 143 a given request to the given API will return a corresponding status code. The test logic 200 is also operative to execute device connectivity emergency testing procedures and communicate the results of the tests to a user of the test logic 200 via the test GUI 133, the service integration test GUI 143, and the GUI 181 based on the type of test being performed and the emergency network being tested. The test GUI 1800 is presented to a test mobile device 205 and enables management of emergency call testing from the test mobile device 205 via a mobile application.

The test logic 200 includes an emergency network entity simulator 317 which is operatively coupled to the front end logic 301 and to the manager logic 300. The emergency network entity simulator 317 may be implemented as an asynchronous microservice that accepts HTTP requests, and is operative to simulate various emergency network entities such as, but not limited to, a call handling system workstation 130, a computer aided dispatch (CAD) workstation 140, and an emergency network entity 180 which may serve as a central station. Similar to the manager logic 300, the emergency network entity simulator 317 supports RESTful Web services and is operative to send and receive RESTful HTTP requests between the emergency data manager 165, the various emergency service supplemental integration providers 160 as well as other data sources 310 including, but not limited to, ALI database 241, RDS 263, LIS 211, validation network 225 entities such as ERDB 255, VDB 257, and MSAG 251, as well as VPCs, and MPCs, etc. In one example, the emergency network entity simulator 317 can simulate the call handling system workstation 130 in the emergency network 100, and listen to all interfaces and communication that occur between the call handling system workstation 130, the CAD workstation 140 and the emergency data manager 165, as well as interfaces to the E911 infrastructure illustrated in FIG. 2 and thereby test E911 related interfaces without causing disruption to communication between the E911 infrastructure and the actual emergency network entity.

In some implementations, non-disruptive testing of a public emergency network 100 such as a PSAP, can be conducted by a private/commercial emergency network entity (ENE) such as the example emergency network entity 180. For example, an alarm service provider that operates an emergency network entity 180 as a central station may, in cooperation with PSAP personnel, test various data interfaces to a PSAP and manage the testing from the private ENE test GUI 181.

In a specific example, the emergency network entity 180 can be provided with a simulated view of the EDM portal GUI 131 as it would appear on the call handling workstation 130. This simulated view would appear within the private ENE test GUI 181 and simulate the interaction and data flows between the call handling workstation 130 and the emergency data manager 165 during emergency calls, or other emergency data that is pushed from the emergency data manager 100 to the call handling workstation 130. The interface between the call handling workstation 130 and CAD workstation 140 is also simulated and tested within the testing framework. Non-disruptive testing operations using the emergency network simulator 317 and other types of emergency call testing operations are described in further detail with respect to FIG. 7 through FIG. 19.

The advantages of using a private/commercial emergency network entity for testing a public emergency network include that, by using a private/commercial emergency network entity as a testing entity, emergency testing can be done without disrupting the emergency response operations at the public emergency network, such as receiving 9-1-1 calls. Performing testing using a private/commercial emergency network entity will ensure that emergency networks are receiving alerts and accurate emergency data, while reducing the burden on emergency infrastructure when performing the test. Additionally, testing via private/commercial emergency network entities in various locations can be done so as to identify problems such as connectivity outages, etc. proactively that may adversely impact multiple public emergency networks serving that area and notify them accordingly.

In some instances, an emergency network may test its own connectivity and services and confirm receipt of emergency alerts and emergency data from various sources. In other instances, a user of a connected device or sensor, such as IoT connected devices, wearables, and connected vehicles, may desire to test the device or sensor connectivity to a local emergency service provider, such as an emergency network. However, in both instances, one of the only means to execute such emergency testing connectivity is to plan an emergency test in advance, which may include scheduling a specific date and time to execute the emergency test at the emergency network, execute the emergency test only at the emergency network location, and obtain clearance from a local authority for executing the emergency test. Given the fragmented nature of most emergency response systems with local emergency response agencies, and in view of the foregoing planning, it can be quite an arduous task to test technology and telecommunication connectivity and services used to save lives. The systems, media, methods, devices, and apparatuses disclosed herein provide an alternative, automated pathway for emergency testing which circumvents the aforementioned barriers and facilitates a non-disruptive means of emergency testing, which allows telecommunicators to respond to actual emergency alerts with minimal disruption.

With respect to service integrations testing, in some implementations, the test logic 200 is operative to verify emergency network workflows on the integrations installed in the emergency network by generating a voice call that will exercise the full data flow and call taking procedure. Results of all tests and any data related to that test execution from both the frontend logic 301 and the manager logic 300 are be stored in the test logic database 309 and unified under a unique session identifier specific to the test execution. Information included in the test report includes, for example, requests made including payloads and query parameters, status codes and response bodies of all requests, distribution events generated by emergency service supplemental integration provider 160 data services related to requests generated by the frontend logic 301, and call flow logic 305 call-flow state change events.

FIG. 4 provides an example of the GUI 143 feature related to test logic 200. The GUI 143 includes service integrations data fields 400 with a list of service integrations 401 that shows each integration installed on the CAD system 140. In some implementations, an active service integration indicator 403 shows whether each specific integration is active for testing purposes. The active service integration indicator 403 may be selectable radio buttons such that the emergency network operator/tester may select which integrations are to be included in a specific test. This may be useful, for example, when one of the integrations previously failed a test, and after troubleshooting and taking corrective procedures, the test is run again only for that specific previously failed integration. A pass-fail indicator 405 indicates whether a specific integration has passed or failed a given test, and an error code indicator 407 provides information helpful toward determining a cause of test failure. For example, a “504 timeout” may indicate a network problem whereas a “401 unauthorized” may indicate a credentials issue.

The GUI 143 also includes emergency network test site ID, date and time fields 409 which display information used in logging the test results. Test parameter fields 410 include a test phone number field 411 and test location fields 413. An initiate voice call test selection field 415 includes a selectable radio button that enables the tester to select whether or not a 9-1-1 call will be made as part of the test procedure. A start test button 417 enables the tester to initiate the integrations test, including a test 9-1-1 call if selected to be included in the test.

The phone number of the test device 205 entered in the test phone number field 411 for use in the testing must be a valid US phone number to which the tester has access (e.g. an emergency network user). This number will receive a call, in the case of a voice test, via the call flow logic 305, and will be prompted by the interactive voice response (IVR) system 315. The IVR system 315 will prompt the test device 205 user to “press 1” to confirm they are executing the 9-1-1 test and, in response to the user pressing 1, will then connect them to 911. Otherwise, the test call will be canceled.

The location entered into the test location fields 413 (i.e. latitude and longitude coordinates) for the test is within the jurisdictional geofence (e.g., the default may be a center point within the geofence) of the emergency network authority's jurisdiction.

Emergency Data Geofencing

In some implementations, when emergency data including, but not limited to, an emergency location or additional emergency data, is sent from an electronic device to the emergency data manager 165, the emergency data is first processed by a geofence module before being received by a set of ingestion modules within the emergency data manager 165. Similarly, in some implementations, when an emergency data request is sent from a requesting party such as one of the emergency network entities, the emergency data request is processed by the geofence module (not shown) before being received by a set of retrieval modules for display on an emergency network entity GUI such as the EDM portal GUI 131. Thus, a geofence analysis may be applied by the emergency data manager 165 to protect potentially sensitive emergency data using geofences. Generally, a geofence is a virtual perimeter for a real-world geographic area.

A geofence can be dynamically generated—as in a radius around a point location—or a geofence can be a predefined set of boundaries such as, but not limited to, school zones or neighborhood boundaries, PSAP jurisdictional boundaries, etc. The use of a geofence is called geofencing, and one example of usage involves a location-aware device of a location-based service (LBS) user entering or exiting a geofence. Entry or exit from a geofence could trigger an alert to the device's user as well as messaging to the geofence operator. The geofence information, which could contain the location of the device, could be sent to a mobile telephone or an email account.

For emergency response, an emergency network such as a PSAP may be given jurisdictional authority to a certain geographical region or jurisdiction (also referred to as “authoritative regions”). In the context of emergency services, one or more geofences may correspond to the authoritative region of an emergency network. Emergency networks are operated by emergency service providers which may be public or private such as commercial providers. An example of a private emergency service provider is a home security company that provides home burglar or fire alarm systems with remote monitoring. Examples of public emergency service providers include police departments, fire departments, a federal disaster management agency, national highway police, etc., which have jurisdiction over a designated area and, in some cases, overlapping areas. Geofences are used to define the jurisdictional authority by various methods and in various Geographic Information System (GIS) formats. In some cases, geofences may only represent authoritative regions if the geofence has been assigned or verified by a local, state, or federal government. However, geofences may represent assigned jurisdictions that are not necessarily authoritative regions. For example, a geofence may be unilaterally created by its associated emergency service provider without verification or assignment by a local, state, or federal government. For example, a private emergency services provider such as a home security company may establish its service area independent from any governmental input.

Geofences can be defined in various ways. For example, a geofence may include one or more of the following: a county boundary, a state boundary, a collection of postal/zip codes, a collection of cell sectors, simple shapes, complex polygons, or other shapes or areas. Geofences may include approximations where the “approximated” geofence encloses an approximation of the authoritative region.

Updates to geofences may be required over time because the authoritative regions may change over time. Geofences may change over time (e.g., a new sub-division has cropped up) and require updates. The systems and methods described herein may allow geofences to be updated (e.g., an emergency network administrator can upload updated geofence GIS shapefiles).

For maintaining the privacy, security and integrity of the data, geofencing may be applied to emergency data. For example, applying geofence filters to the emergency data allows additional avenues for monitoring, both visibility and control, over the emergency data manager 165 to detect anomalies/spikes and reduce the risk of security breaches.

In some implementations, the geofence verification test may be done by the emergency network. The test may be done with various locations within the authoritative jurisdiction of the emergency network to test whether emergency data and the call routing is correct when an emergency test call is made from various locations. Also, locations outside the geofence (near the boundaries) may be tested to make sure that they are not being mistakenly routed into the emergency network. The test logic 200 is operative to facilitate such emergency call tests.

Referring to FIG. 4, the user is able to change this location to another point within their authority's jurisdiction. A user-supplied location that is outside of the emergency network jurisdiction is automatically rejected and the test will not be run in that case. Additionally, if the test is to include a voice call test by the user making the appropriate selection in voice call test selection field 415, the phone number location is verified to be sure that it is within the call-routable United States. If the phone number location is determined to be outside of the U.S., then the test will not run.

When an emergency network tester clicks the start test button 417 to execute a test, the GUI 143 displays a confirmation screen with the full data they can expect to see in the test asking them to confirm they want to initiate a test. The user is required to press an additional button to confirm and initiate the test, or can press a cancel button to cancel the test.

After the emergency network tester initiates a test, the frontend logic 301 triggers the integrations test and the manager logic 300 simulates each installed integration. The data collection logic 311 sends and receives RESTful HTTP requests 313 to and from the various emergency service supplemental integration providers 160 and other data sources 310 as needed for information verification, and information is consumed by the manager logic 300. For example, information may be obtained from the LIS 211, the ALI database 241 or from validation network 225 entities. The data collection logic 311 is operative to receive emergency data from the emergency data manager 165, where the emergency data manager 165 is operative to receive data from various sources including, but not limited to, mobile device generated location data, medical database data, and other data, etc. The manager logic 300 serves as an endpoint to all APIs, performing test setup, test start, and sending results to the logger 303. Additionally, the manager logic 300 manages the tests, and triggers and emergency-API call flow via the call flow logic 305. Because the tests themselves are stateful the data cache 307 is used by the manager logic 300 as central storage for running tests. The frontend logic 301 and logger 303 may also be operative to access the data cache 307. The manager logic 300 is also operative to manage and communicate with the emergency network entity simulator 317 and likewise may serve as an API endpoint, perform test setup, test start and sending test results to the logger 303. In some cases, depending on the type of test, the emergency network entity simulator 317 may serve as an API endpoint. In one specific example, the emergency network entity simulator 317 may simulate an API endpoint for the emergency data manager portal GUI 131 as if it were being displayed on an emergency network entity such as the call handling workstation 130, and observe or handle various RESTful HTTP requests.

The call flow logic 305 is operative to begin a call flow to originate a call to 9-1-1 and the emergency network under test from a test device 205. Emergency 9-1-1 calls are routed to the nearest emergency network based on latitude and longitude (i.e. x/y routing). If the system is provided with an invalid or incorrect latitude or longitude, the call will be routed to a wrong emergency network, or there may be no emergency network valid for the incorrect location. The test logic 200 is operative to validate 9-1-1 location flow and simulate a real 9-1-1 call, end-to-end. Also, in this testing scenario, the emergency network entity simulator 317 may serve as an API endpoint, etc. toward validation of 9-1-1 location flow as well as flow of other related emergency data or establishment of other communication channels, including other APIs.

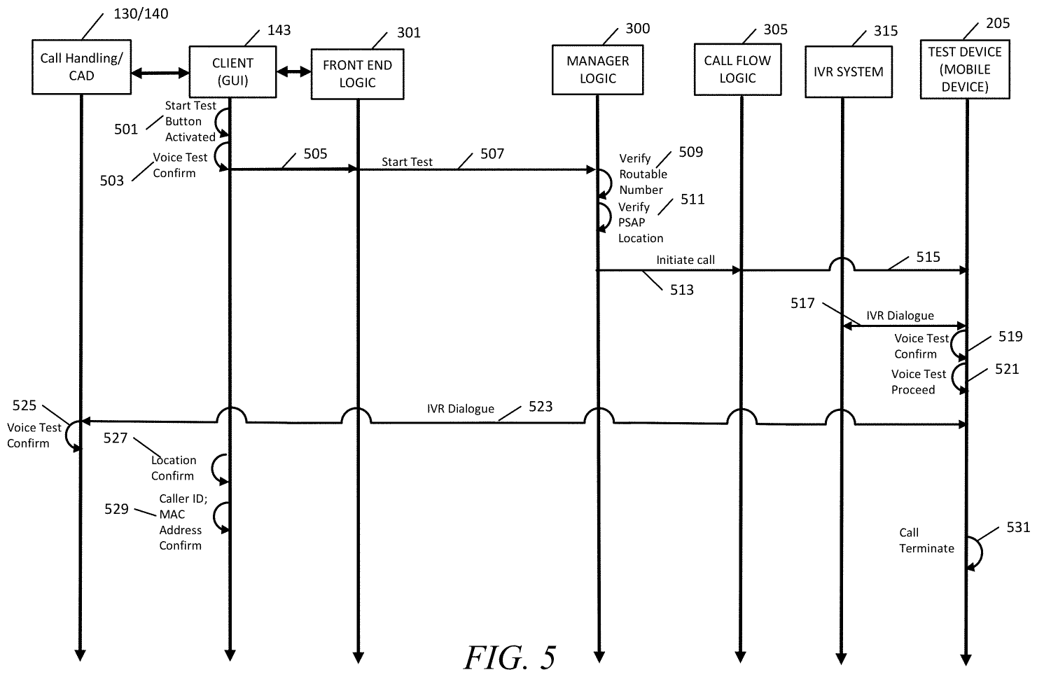

FIG. 5 is a message flow diagram that provides an example implementation of a 9-1-1 call simulation. Test device 205 (i.e. a mobile phone) posts location to an emergency services supplemental integration provider 160 via a supported protocol, and then originates a call to 9-1-1. The wireless network routes the phone-call to the nearest emergency network which will be the emergency network under test. The emergency network queries the emergency services supplemental integration provider 160 or the emergency data manager 165, for location via a supported protocol. The test logic 200 monitors the location request in order to validate that the emergency network has indeed queried the information (e.g., by checking the credentials associated with the query) and was provided with the correct location.

At operation 501, the emergency network test pushes the start test button 417 on the GUI 143 and is prompted to confirm the voice test at operation 503. The GUI 143 communicates with the front end logic 301 and sends the start test command 505. The front end logic 301 initiates the test with the manager logic 300 via command 507. At operation 509, the manager logic 300 verifies that the phone number for the test device, entered into the test phone number field 411, is a valid US phone number. At operation 511, the manager logic 300 verifies that the location entered into the test location fields 413 is a valid location covered by the emergency network under test. If one of these requirements is not met, the test will be aborted. If both requirements are met, the manager logic 300 will send a call initiate message 513 to the call flow logic 305 and the call flow logic 305 will initiate a call from the test device 205 via message 515. An IVR dialogue 517 will be started with the test device 205 user, and the user will be prompted to confirm the test as shown by operation 519. If the test is confirmed, the IVR dialogue 517 may further prompt the user to initiate the voice test and place the call at operation 521. An emergency call will then call the emergency network call handling system 130 and CAD system 140 will display test activity on the GUI 143.

An IVR dialogue 523 may be started with the emergency network operator/tester such that the tester will be prompted to confirm the test call at operation 525. In that case, the tester will also be asked to confirm the location at operation 527 and may also be asked to confirm the caller ID or other information at operation 529. The call is then terminated at operation 531.

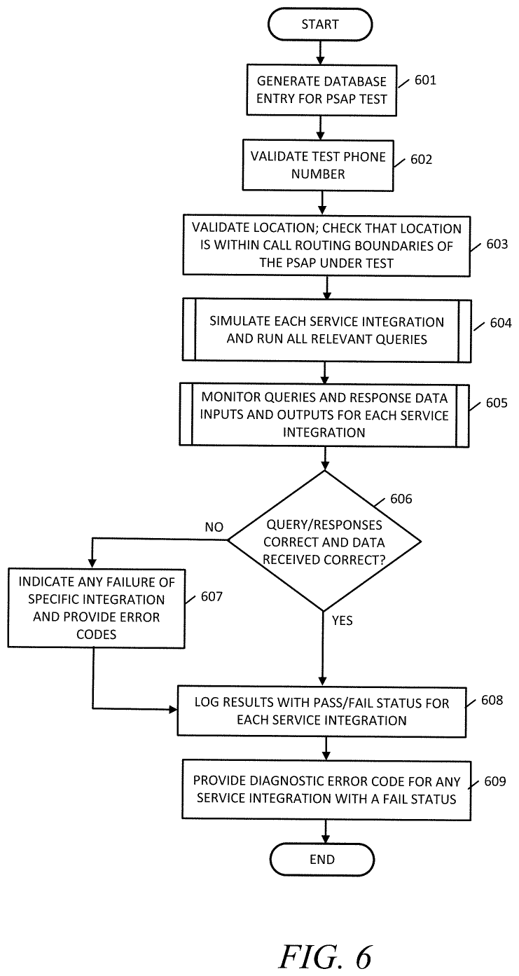

FIG. 6 is a flowchart showing an example method of operation of the test logic 200. The method of operation begins, and in operation block 601, the test logic 200 generates a database entry in the test logic database 309. In operation block 602, the test logic 200 validates a test phone number entered in the GUI to verify that it is a valid U.S. phone number. In operation block 603, the test logic 200 checks the location entered in the GUI to verify that it is within the call routing boundaries of the emergency network under test. In operation block 604, the test logic 200 simulates each service integration and runs all relevant queries. In operation block 605, the test logic 200 monitors queries from the emergency network and response data for each service integration.

At decision block 606, the test logic 200 determines if the emergency network queries are correct and if a response is received and if it is correct, for each query from each integration. If not, then in operation block 607, the GUI 143 is updated to reflect the status for the integration in error, and an error code is provided for troubleshooting. In operation block 608, the test results and pass or fail status is logged in the test logic database 309 for each service integration tested. In operation block 609, the test logic 200 logs the error code along with any failed status. The method of operation then ends as shown.

The emergency phone call testing by the test logic 200 tests both mobile wireless network calls as well as calls in which the test device acts as a SIP phone (i.e. VoIP end point) utilizing the VoIP call routing network 215 infrastructure. The testing accommodates over-the-top VoIP applications as well as testing VoIP calls over managed VoIP services specified by the wireless operator for voice calling on an LTE network. The test logic 200 may also test emergency text messages or an IP emergency message (i.e. an “IM” instant message from a messaging application).

It is to be understood that test validation procedures between the emergency network operator/tester and the test mobile device operator may vary in accordance with various emergency network authority requirements or preferences. For example, the test device/mobile phone operator may speak to the emergency network operator during the emergency test call. However, in other implementations in which the call is automated, the emergency network operator will hear only an automated recording, for example from IVR system 315. The test device/mobile phone operator may also receive a message (such as a short-message-service (SMS) text message) notifying them that the emergency call test was successful. In other implementations, the test device/mobile phone operator may receive a message prompting them to take certain actions such as, but not limited to, clicking a link; typing or cutting and pasting a link into a web browser; etc. where the link is used to further validate the test. As described with respect to FIG. 5, various IVR dialogues may be used. IVR dialogues may be presented at both the emergency network operator leg of the call and also on the test device operator leg. For example, the IVR dialogues may prompt the emergency network operator to provide certain information to validate key information from the test, such as an IVR prompt asking the emergency network operator to press “1” if location is available on their screen/display and press “2” if it is not. Another example IVR prompt may be “please read the address displayed on your screen” such that the IVR system 315 may record the emergency network operator's vocal response.

In other examples, the IVR system 315 may recite or repeat back key information such as a location/address and query the emergency network operator to confirm the information is correct, for example an IVR system 315 dialogue may ask, “I heard 123 Main Street, Rockport, Ind. from you—is that correct?”

The emergency call testing procedure example shown in FIG. 5 may also be used for testing emergency text message (SMS or IM messages). In those test situations, the test device generates a text message is generated. In FIG. 5 at operation 513, the manager logic 303 and call flow logic 305 may prompt the test device 205 to send the text message which may be automatically generated. The voice test verification operation 519 and voice test proceed operation 521 may in that case be used to verify and proceed with the text message test procedure. In some implementations, a call may still be made to the emergency network operator in order to utilize the IVR system 315 which may likewise interact with the emergency network operator as in operation 523, however the dialogue used is applicable to the text message and may have additional or different user queries than the voice call testing dialogue. Location confirmation operation 527 and caller ID or MAC address confirmation operation 529 are likewise applicable to the SMS or IM test procedure. Otherwise, rather than using the IVR system 315, user prompts and queries are made within the GUI 143, and emergency network operator responses are recorded to the test logic database 309.

Multimedia application emergency messages may also be tested. In that case, a MAC address and IP address of the device is utilized within the IP domain to determine a location for the test device which may be a mobile phone or a laptop, desktop, tablet, etc.

The test data logger 303 of the test logic 200 is operative to log events and data for each of these types of tests such as, but not limited to, call/message delivery time; call/message quality (e.g. jitter, packet loss, etc.); confirmation that all information was delivered to the emergency network; the emergency network operator's ability to interpret received data (e.g. floor height or a multimedia feed), etc.

The testing of emergency calls or messages, or other alerts, is used to confirm, discover, or validate that: all data is displayed, that data can correctly be interpreted, that an emergency voice call, message or alert properly connects, that data flows through various software systems and service integrations (e.g. from the emergency call handling system 120 to the call handling system 130 and into the CAD system 140 and/or into intelligent middleware or radios. Other data connections to the emergency network that may be tested include, but are not limited to, display of a photo or video, testing of procedures to validate that a human is sending the emergency message or placing the emergency call (i.e. not robotically generated), determining the type of software running on an emergency network entity (such as the call handling system workstation 130, the CAD system 140 or both), testing of network conditions (such as packet delay, network lag, etc.), test for or discover security vulnerabilities (such as vulnerabilities in firewall 203, etc.), determine encryption systems utilized, map out the network and/or develop a pathway for network traversal.

In some implementations, test logic 200 may be operative to identify potential threats to network security such as, but not limited to, identifying network nodes or end devices that may harbor potentially malicious code or may be otherwise compromised. The test logic 200 may in some instances, send a continuous stream of data traffic to suspicious devices at sufficient volume under test conditions, to simulate a denial-of-service (DOS) attack on that node or device. If the node or device fails the DOS simulation, corrective actions can be taken. The test logic 200 may also simulate incoming DOS attacks to test the firewall 203 for example.

FIG. 7 provides an example of the test GUI 181 provided by the test logic 200. The test GUI 181 is used by a private or commercial security services provider for testing connectivity between private or commercial security systems, the emergency network entity 180 and a public emergency network. The tests can be performed in a non-disruptive manner in that the public emergency network entity 130 and corresponding public emergency network EDM portal GUI 131 can be simulated so as to avoid sending test alerts to the public emergency network 100. The test GUI 181 includes a test information field 701 which displays user identification, and a test type. The user identification field may provide a user identifier of a user authorized to access and/or run testing procedures on a given emergency network entity. The test type specifies the test to be run or in operation and may be selected from a pull-down menu or entered in via manual entry. Example test types include, but are not limited to, emergency data test, emergency voice call tests, specific interface tests, DOS attack test, or other tests, etc. In some implementations, the test GUI 133 includes an emergency network selection field 703, such as a pull-down menu 705 that provides a selectable list of emergency networks 707 available for emergency testing. In other implementations, the test GUI 133 may only run tests for an emergency network entity corresponding to the emergency network entity that the user is logged in to and is authorized to access. In such an implementation, the user associated with the emergency network entity may be initiating an emergency test.

When non-disruptive testing is facilitated by a private/commercial emergency network, the test GUI 181 may be provided to, and displayed on, the emergency network entity 180 which may serve as, for example, a central station. In that scenario, the emergency network field 703 may also include customer information, such that communication and/or interfaces with a private/commercial system may be tested.

The test GUI 181 also includes a map view window 709 that may display a portion of a geographic region associated with an emergency network selected via the pull-down menu 705. The map view 709 may be determined by, and limited to, a geofenced region corresponding to the selected emergency network. The test GUI 181 includes user selectable buttons including a start test button 711, cancel button 713, and an identify devices button 715. The cancel button 713 cancels any emergency network selection to allow selection of a different emergency network. The start test 711 button moves the test GUI 181 to another view corresponding to the particular test type shown in the data field 700. The identify devices button 715 moves the test GUI 181 to a data entry view in which the user may enter information for a test device 205 such as, but not limited to, phone number, MAC address, location coordinates, username, or other information that may be used for testing purposes.

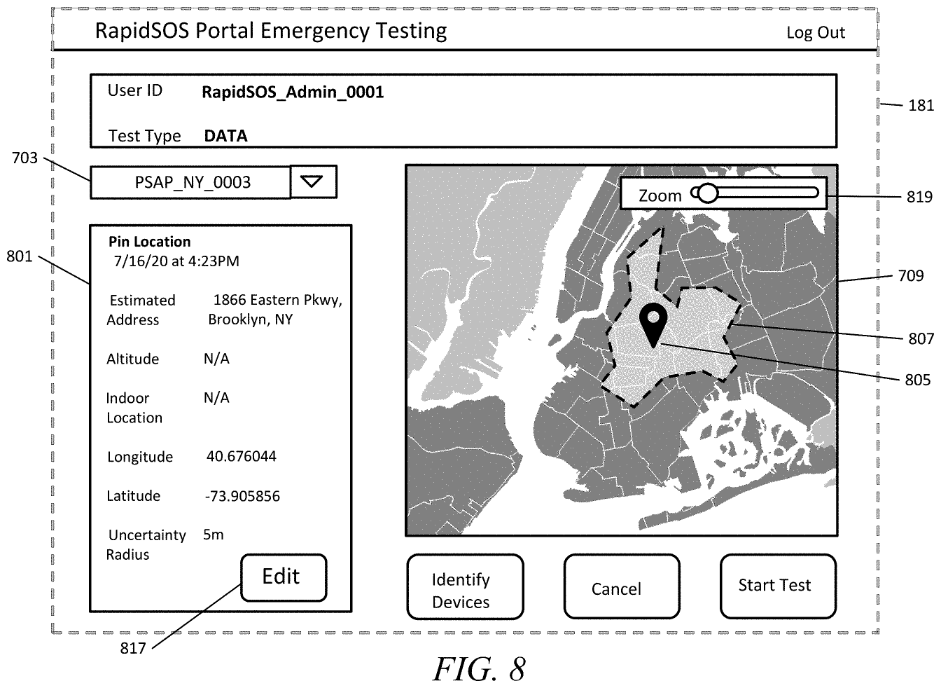

FIG. 8 provides another window of the test GUI 181. The test GUI 181 window shown in FIG. 8 displays a location data field 801 that includes an address of a test location indicator 805, altitude, indoor location, longitude, latitude, and uncertainty radius. The test location indicator 805 shows a selected location of a private or commercial alarm system or sensor that will be used in the test procedure to correspond to a test emergency alert that would be pushed to the public emergency network 100. The location is selected to be somewhere within any geofence defining the perimeter of authority for the emergency network under test. Thus, the alarm system or sensor to be tested must be located such that the test location indicator 805 is positioned at a point within a geofence 807 for which the selected emergency network 803 to be tested is associated. Alternatively, the test device and corresponding test location indicator 805 may be positioned at a boundary point of the geofence 807, or in a buffer region of the geofence 807. A buffer region may, for example, extend no more than a threshold distance from the boundary of the geofence 807, where the threshold may be any arbitrarily selected distance such as between one meter and ten meters, or some other distance. The location data field 801 includes an edit button 817 which, when selected, enables data entry fields for user input of the estimated address, altitude, indoor location, longitude, or latitude. The map view window 709 may update the test location indicator 805 according to the user input. The map view window 709 may permit a user to select a test location within the map view window 709 or drag and drop the test location indicator 805 to a new test location. A user will receive an error message if a test location falls at least outside the buffer region of the geofence 807, and the test location indicator 805 will reset to a default test location which may be a point central to the geofence 807. The map view window 809 may include a user selectable zoom slide bar 819 for maximizing and minimizing the geographic region within map view window 709.

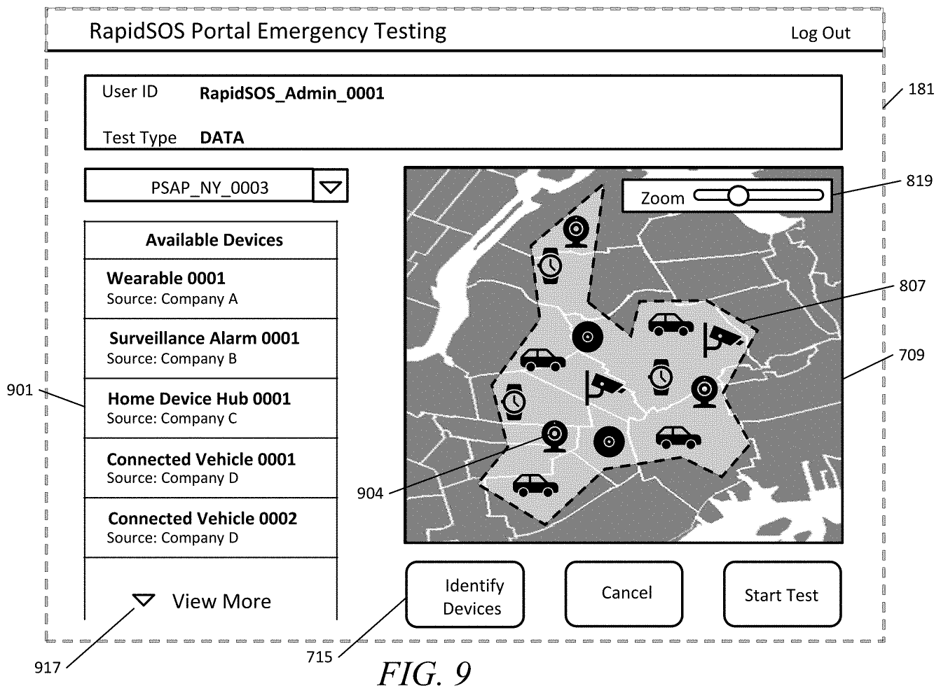

FIG. 9 provides another example window of the test GUI 181 that includes an available devices list 901. The available devices list 901 is populated with customer devices which correspond to customers of the private or commercial emergency network and that are available for emergency testing within the geofence 807. The available devices list 901 is displayed after a user selects the identify devices button 715. An available test device 904 may be selected from the available devices list 901 or on the map view window 909. As the user selectable zoom slide bar 819 is adjusted, more or less test devices become visible in the resulting minimized or maximized viewable portion of the map view window 709.

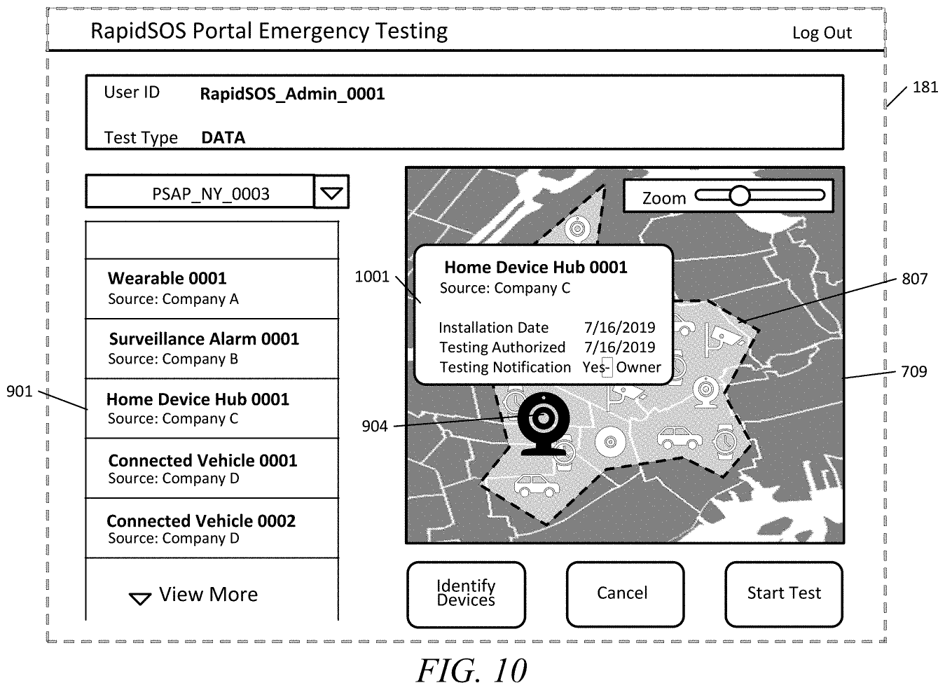

FIG. 10 provides another example window of the GUI 181 that includes a device data field 1006 for test device 904 which has been selected. The device data field 1001 is displayed after a user selects available test device 904 from the map view window 709 or available devices list 901, and the user selection causes the available test device 904 indicator to increase in size relative to other available test devices in the map view window 709, as well as causes the available test device field in the available devices list 901 to indicate the selection.

The device data field 1001 may include information associated with the selected test device 904. The customer device selected for testing in the FIG. 10 example is “Home Device Hub 0001” and the device data field 1001 includes the customer name, source, and installation date of the device, and may also include an indication that a user authorized emergency testing at a known date and that the user will be notified of an emergency test of the device. The information associated with the available test device 904 may include other information which may depend on the device type. For example, the information in device data field 1001 may include different information for a connected vehicle and a wearable device. The information associated with the available test device 904 may include other information which may depend on available data. For example, the information in device data field 1001 may include the date of the last emergency test, but if no emergency test has been executed, a date may not be displayed in device data field 1001.

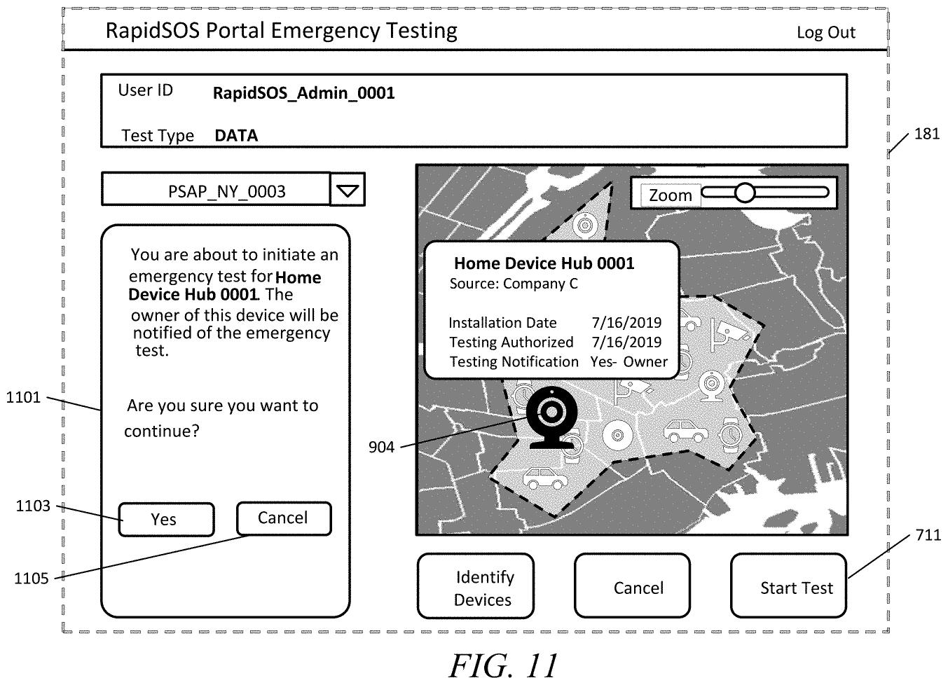

FIG. 11 provides another example window of the GUI 181 in which a pop-up query 1101 is displayed after selection of the start test button 711. The pop-up query 1101 requires user verification that the test should continue or otherwise cancel the test procedure.

After a user selects the confirmation button 1103, the frontend logic 301 initiates an emergency test and the manager logic 300 triggers an emergency alert from the available test device 1104. In some implementations, available test device 904 may include an emergency testing mode triggered by the manager logic 300. In such an implementation, the emergency testing mode causes the available test device 904 to trigger an emergency alert. In other implementations, available test device 904 may not include an emergency testing mode, and the manager logic 300 may trigger an emergency alert by transmitting a request to initiate an emergency alert to a user associated with the available test device 904, or the manager logic 300 may trigger an emergency alert by transmitting data to the available test device 904 to indicate an emergency and cause the available test device 904 to trigger an emergency alert. For example, manager logic 300 may transmit simulated data to a device to indicate an emergency, such as transmitting current flow data to an ionization-type connected smoke detector indicating smoke entered a chamber and disrupted ion flow between two electrically charged plates in the chamber.

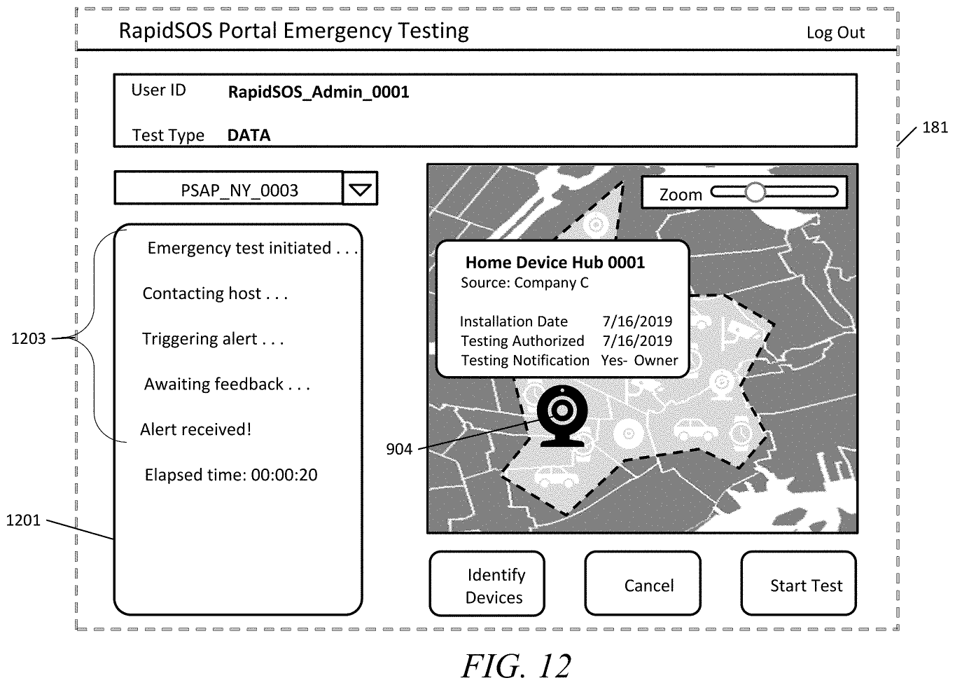

FIG. 12 provides another example window of the GUI 181 that includes a test window 1201 displaying status updates 1203 after initiation of an emergency test. The manager logic 300 monitors for the status updates 1203, to determine whether an emergency alert has been received at an emergency network entity for the selected emergency network 803. The emergency network entity simulator 317 may simulate the public emergency network entity and may also provide a simulated EDM portal GUI 182 at the emergency network entity 180 performing the testing operation. In other words, the test alert may not actually be sent to the emergency network in order to avoid disruption of actual emergency responses.

For example, the emergency network entity simulator 317 may simulate the call handling workstation 130 and provide the simulated EDM portal GUI 182 on the emergency network entity 180. When the test alert is sent from the test device, it is received at the emergency network entity 180, acting as a central station, and APIs between the simulated call handling workstation 130 and the emergency network entity 180 are invoked. The emergency data manager 165 may also be included in the test procedure, and may receive the test alert from the test device. It is to be understood that various alarm system configurations and architectures may be tested using the disclosed system. For example, in some system architectures the emergency data manager 165 may receive emergency alerts and pass them along, for example via a push operation, to the emergency network entity 180 which may be serving as a central station. The emergency data manager 165 may further be responsible for determining alarm validity and whether or not the alarm would be pushed to an emergency network entity. A central station may or may not be involved in alarm validity determination, and/or pushing an emergency alert to an emergency network entity. In other words, there may be various configurations of interoperation between the emergency data manager 165, the emergency network entity 180 and a public emergency network entity such as, but not limited to, the call handling workstation 130. Thus, disruption to a public emergency network is avoided and testing of various interfaces and communications of data that occur prior to an emergency alert arriving at a public emergency network entity are tested by the disclosed systems, apparatuses and methods. It is also to be understood that the public emergency network 100 may choose to be directly involved in testing and, in that case, the test GUI 133 is operative to display all of the testing operations described herein locally to a public emergency network entity operator. However, in the non-disruptive testing scenario described herein, a public emergency network entity is simulated and the EDM portal GUI 131 is simulated in a mirrored version as simulated EDM portal GUI 182 displayed on the emergency network entity 180. The simulated EDM portal GUI 182 enables a testing operator to determine whether an emergency alert or an emergency call is being received and properly displayed on the actual EDM portal GUI 131 as would be displayed on, for example, the call handling system workstation 130.

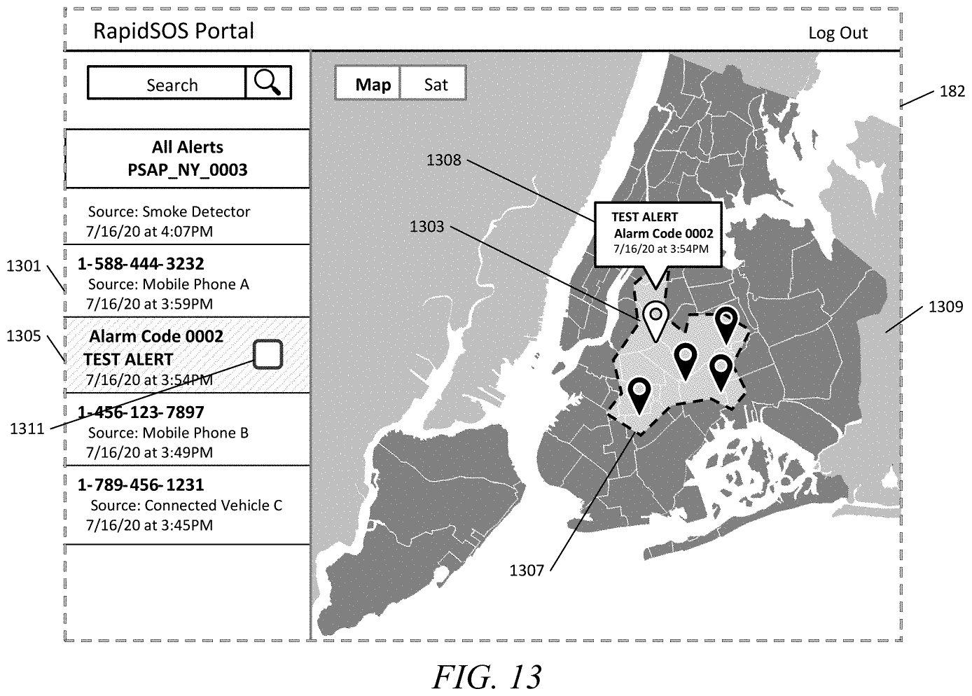

FIG. 13 provides an example of the simulated EDM portal GUI 182, which is a simulation of the actual EDM portal GUI 131 displayed on the call handling system workstation 130. If the test emergency alert is successfully pushed to the simulated public emergency network entity, then the test emergency alert 1305 will appear in the emergency alert queue 1301. The test emergency alert 1305 may include a user selectable checkbox 1311 to verify that the test emergency alert 1305 has successfully appeared in the emergency alert queue 1301. Additionally, a test alert location indicator 1303 may be is displayed in a map view 1309 in a special distinguishing color, or flashing or using some other visual queue to distinguish it and to identify it as being test related. Moving the cursor over the test alert location indicator 1303 may display a test alert information pop-up 1308. The map view 1309 displays emergency alerts within a geofence 1307 which is the same geofence displayed on the test GUI 181 view based on selection of the emergency network being tested. Because the map view 1309 is displaying the geofence 1307 from the public emergency network 100 operator's perspective, all location indicators displayed within the map view 1309 correspond to the emergency alert queue 1301 and are within the geofence 1307.

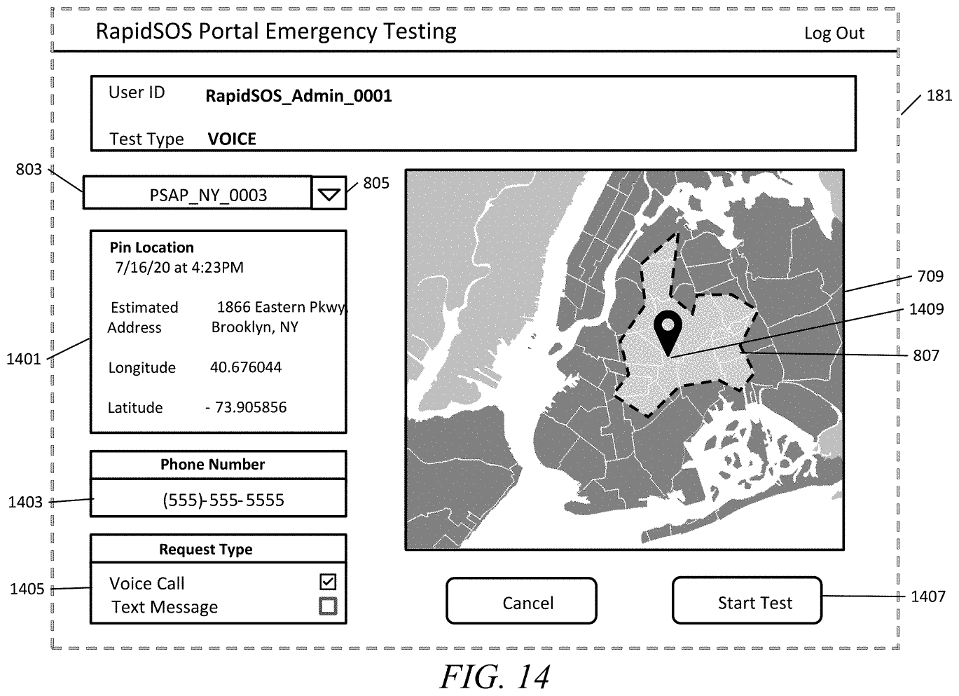

FIG. 14 provides another example window of the GUI 181 from which an emergency call test procedure can be initiated and managed. A selected emergency network 803 can be selected using the pull-down menu 805 as in previous windows. In this case, a test emergency call is sent from a test device 205. The test may be performed such that the call is routed to the public emergency network 100 with involvement by the public emergency network staff. However, some non-disruptive testing may also be performed by the emergency network entity 180 using the emergency network entity simulator 317. In the case of simulation, the testing simulates transmission of emergency data from the test device 205 to the emergency data manager 165 and whether the correct data is displayed on the simulated EDM portal GUI 182. An emergency call using 911 is not actually placed to the emergency network 100 to avoid disruption of actual 911 emergency calls and responses. However, an emergency call may be tested using the procedures discussed with respect to the service integration test GUI 143 as discussed with respect to FIG. 4.

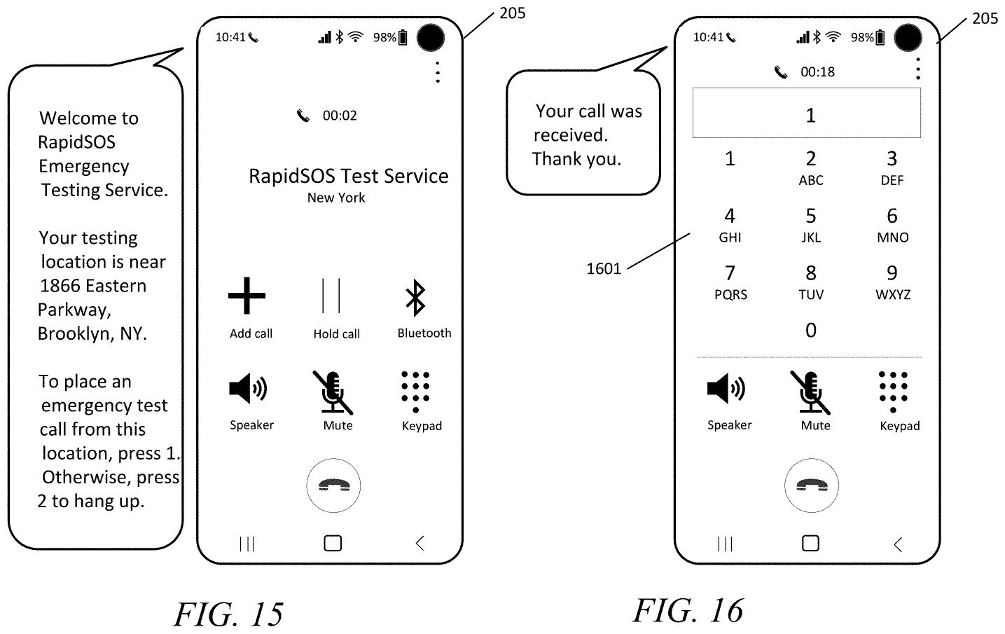

In the test GUI 181 window shown in FIG. 14, a location data field 1401 displays an estimated address of a test location indicator 1409, longitude, and latitude. The test location indicator 1409 may be at a point central to the geofence 807 for selected public emergency network 803. A phone number field 1403 is for entry of a test device 205 phone number and a request type field 1405 includes user selectable checkboxes such that either a voice call or a text message may be tested from the test device 205. In the case of emergency call and text messaging testing, the test device 205 may not, and need not, be in physically located within the geofence 807. Therefore, the test location indicator may show a mock test location. By selecting the start test button 1407 a test call is initiated and the manager logic 300 invokes the call flow logic 305 to begin an IVR voice call to the test device 205. FIG. 15 provides an example IVR audio message and voice prompt received at the test device 205. The test device 205 user acknowledges answers the IVR call and responds to the IVR prompt by either vocally responding or by making a keypad entry, such as by pressing “1” as shown in FIG. 16.

The IVR system 315 will convey the test location to the user of the device for confirmation and then prompt the user to input, by voice or by keypad 1601, a number to confirm execution of the emergency test voice call alert. Responsive to receiving the proper input to execute the emergency test voice call alert via the IVR system 315, the call flow logic 305 will originate a call to 9-1-1 using the longitude and latitude of the test location to route the call to the appropriate emergency network entity which will initiate an alert field 1305 and corresponding test alert indicator 1303 in an emergency alert application provided by CAD system 140 or the emergency data manager 165.

The call flow logic 305 may further tag the call with a simulation identifier to indicate the call is a test call simulated by the test logic 200. The simulation identifier may be a key or string used by an emergency services system, such as shown in the example in FIG. 2, to identify the call as a test call. Responsive to determining that the call is a test call, devices associated with the emergency network entity will enter into a passive mode which will cause the devices associated with the emergency network entity not to ring, vibrate, or otherwise indicate that voice assistance is required. The passive mode will route the test call to a messaging system associated with the emergency network entity, which indicates that the test call was received. In this implementation, a receipt of the test call may be detected by the manager logic 300 after selection of the emergency alert in the emergency response application, or after selection of the emergency alert in the emergency response application as well as determining the test call was routed to the messaging system. After the manager logic 300 detects a receipt of the test call, a voice message is communicated to the user of the device associated with the phone number via IVR system 315 as shown in FIG. 16.

In other implementations, a text-based emergency test is initiated. In such an implementation, after a phone number is input in phone number field 1413, the text message request type is selected in request type field 1415, and a user selectable start test button 1417 is selected in the GUI 133, the frontend logic 301 triggers an emergency test and the manager logic 300 triggers a text-based message, such as an SMS or IM message, to a device associated with the input phone number.

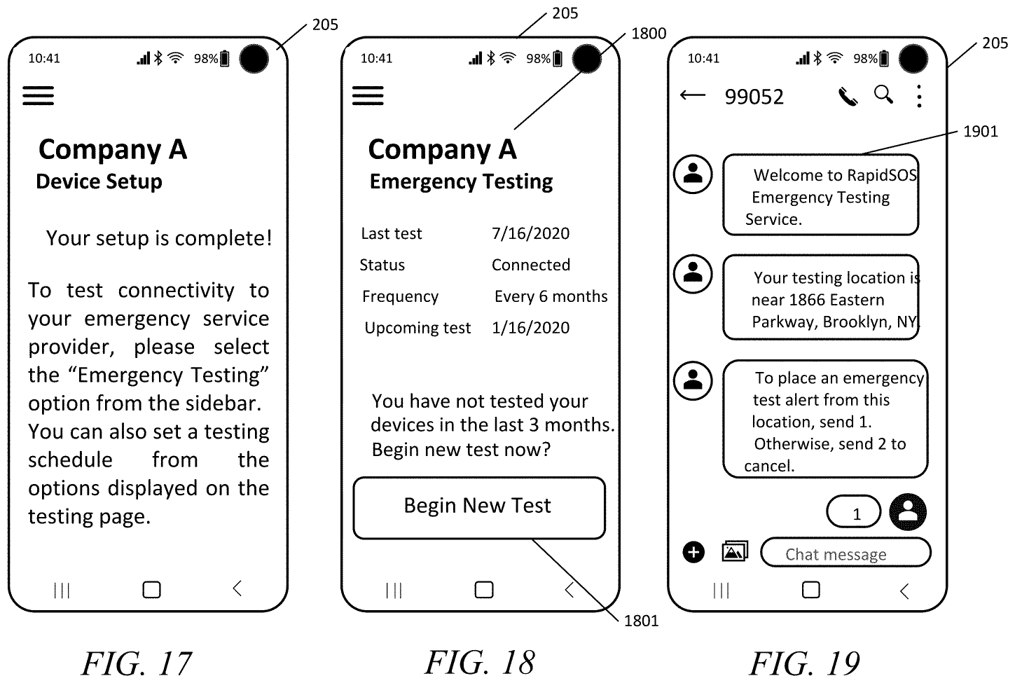

FIG. 17 through 19 provide examples of a GUI of a device associated with the input phone number. After the manager logic 300 triggers a text-based message, such as SMS message 1901, a user of the device associated with the input phone number is prompted to respond to the text-based messages to confirm execution of the emergency text-based test alert.

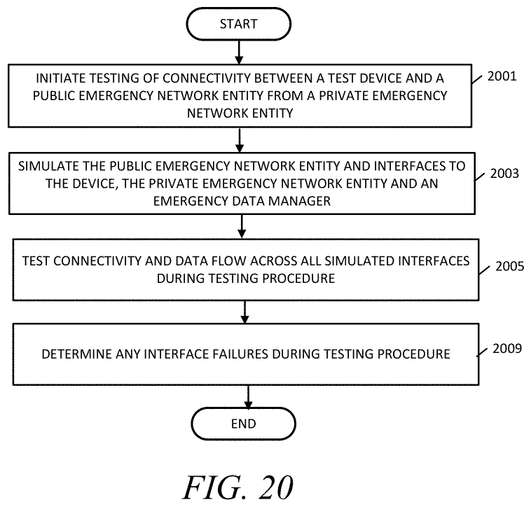

FIG. 20 is a flowchart showing an example method of operation of the test logic 200. The method of operation begins, and in operation block 2001 the test logic 200 is invoked by a private emergency network entity 180 to initiate testing of connectivity between a test device and a public emergency network entity 130. The test device may be for example, an alarm system or alarm system sensor that is located at a customer premises serviced by the private emergency network entity 180, in cases where the private emergency network entity 180 serves as a central station. In emergency call or emergency text message testing scenarios, the test device may be a test mobile 205 that is utilized for purposes of testing whether various types of emergency data is correctly arriving at the emergency data manager 165, such that the emergency data can be correctly pushed to a public emergency network entity. In that case, the private emergency network entity 180 may also display a simulated EDM portal GUI 182 which may be a mirror of the EDM portal GUI 131 that would be displayed on call handling workstation 130 for example. In the case of testing customer alarm systems and sensors, the private emergency network entity 180 displays the private emergency network entity test GUI 181 from which the testing of various devices and their connectivity to the private emergency network entity 180, and to the emergency network 100 is tested. In order to avoid disruption of the emergency network 100, the private emergency network entity 180 performs the test independently from the emergency network 100, and a public emergency network entity such as the call handling system workstation 130 is simulated by the emergency network entity simulator 317. The emergency network entity simulator 317 may be an asynchronous micro service that is operative to simulate all APIs and other interfaces between the emergency data manager 165, the emergency network entity 180, the simulated public emergency network entity and other various interfaces. In operation block 2003, the emergency network entity simulator 317 simulates the public emergency network entity such as the call handling workstation 130, and all inbound and outbound data flows and interfaces from the public emergency network entity to the emergency network entity 180 and to the emergency data manager 165. In operation block 2005, the test logic 200 tests the connectivity and data flows across all simulated interfaces during the test procedure. In operation block 2009, the test logic determines any interface failures that may have occurred during the testing procedure and generates reports accordingly. The method of operation then terminates as shown.

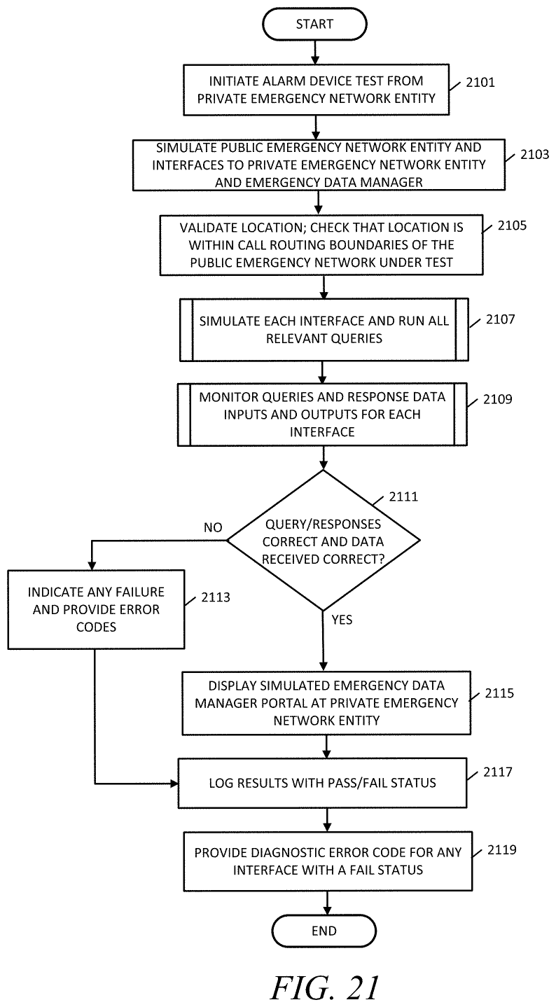

FIG. 21 is a flowchart showing further details of an example method of operation for testing alarm device connectivity. The method of operation begins, and in operation block 2101 the test logic 200 is invoked by a private emergency network entity 180 to initiate testing of connectivity between an alarm system or alarm system sensor that is located at a customer premises serviced by the private emergency network entity 180, the emergency data manage 165 and the public emergency network 100. In operation block 2103, the emergency network entity simulator 317 simulates the public emergency network entity such as the call handling workstation 130, and all inbound and outbound data flows and interfaces from the public emergency network entity to the emergency network entity 180 and to the emergency data manager 165. In operation block 2105, the test logic 200 checks the location entered in the GUI 181 for the alarm system or sensor to be tested is located within the call routing boundaries of the public emergency network 100 (which is the emergency network selected to be used in the test). In operation block 2107, the test logic 200 uses the emergency network entity simulator 317 and simulates each interface and API between the emergency network entity 180, the emergency data manger 165 and a public emergency network entity such as the call handling workstation 130, and runs all relevant queries. In operation block 2109, the test logic 200 monitors the queries from each emergency network entity, etc. and response data flows.

At decision block 2111, the test logic 200 determines if the queries are correct and if a response is received and if it is correct, for each query on each interface or API. If not, then in operation block 2113, the GUI 181 is updated to reflect the status for the error, and an error code is provided for troubleshooting. If at decision block 2111 all interfaces are correct, the data is displayed in a simulated EDM portal GUI as shown in decision block 2115. The simulated EDM portal GUI shows the data as it would be displayed to the public emergency network operator. In operation block 2117, the test results and pass or fail status is logged in the test logic database 309 for each service integration tested. In operation block 2119, the test logic 200 logs the error code along with any failed status, and the method of operation then terminates.

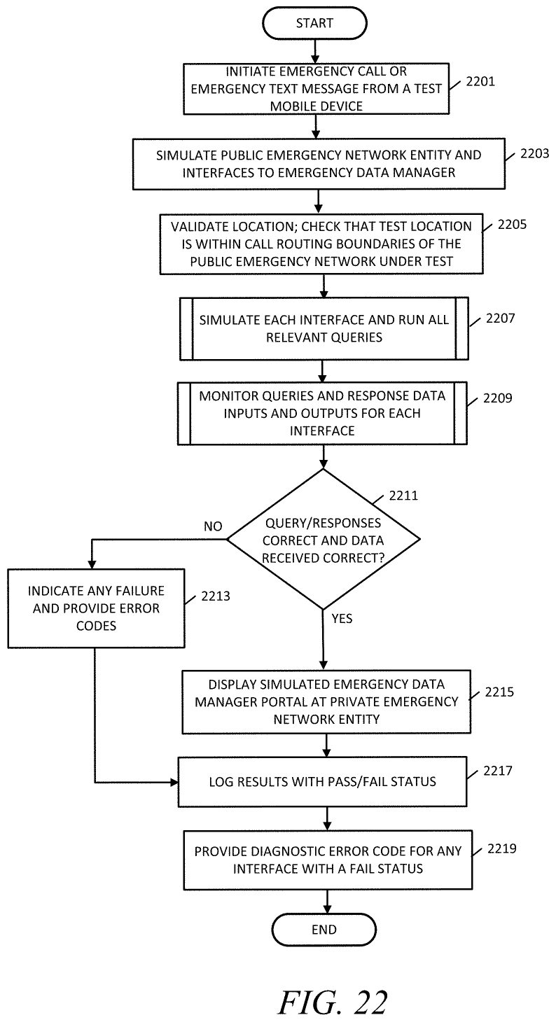

FIG. 22 is a flowchart showing further details of an example method of operation for testing emergency call related emergency data reception connectivity. The method of operation begins, and in operation block 2201 the test logic 200 is invoked by a private emergency network entity 180 to initiate testing of an emergency call or emergency text message from a test device 205 to the private emergency network 100 and all associated emergency data flows. The testing may be non-disruptive in that an actual emergency call to the public emergency network 100 is not placed. Instead, a phone call is placed using a phone number for a simulated public emergency network entity. The data flows associated with the call are identical to those that would occur from the test device 205 to various databases and obtained by the emergency data manager 165. The emergency data is then pushed to a simulated public emergency network entity to test the interfaces while avoiding any disruption to actual 9-1-1 emergency call takers work flow and operations. Thus, in operation block 2203, the emergency network entity simulator 317 simulates the public emergency network entity such as the call handling workstation 130, and all inbound and outbound data flows and interfaces from various network infrastructure which may be E911 infrastructure as described with respect to FIG. 2, and to the emergency data manager 165. In operation block 2205, the test logic 200 checks the location entered in the GUI 181 for the test device 205 to be sure that the location entered is within the call routing boundaries of the public emergency network 100 (which is the emergency network selected to be used in the test). In this scenario, the location may be a mock test location and not the actual location of the test device 205, unless the test device 205 happens to be located within a geofence associated with the emergency network being specified for the test. In operation block 2207, the test logic 200 uses the emergency network entity simulator 317 and simulates each interface and API between the emergency data manager 165, a public emergency network entity such as the call handling workstation 130, and interfaces from various network infrastructure which may be E911 infrastructure, and runs all relevant queries. In operation block 2109, the test logic 200 monitors the queries from each interface, etc. and response data flows.

The remainder of the test procedures is similar to the test procedure described with respect to FIG. 21. At decision block 2211, the test logic 200 determines if the queries are correct and if a response is received and if it is correct, for each query on each interface or API. If not, then in operation block 2213, the GUI 181 is updated to reflect the status for the error, and an error code is provided for troubleshooting. If at decision block 2211 all interfaces are correct, the data is displayed in a simulated EDM portal GUI as shown in decision block 2215. The simulated EDM portal GUI shows the data as it would be displayed to the public emergency network operator such as an emergency call received in an emergency call queue and any associated available emergency data. Various mock information elements may be setup in advance and associated with the specific test mobile device 205 such that the mock information elements are transferred during the procedure to validate that emergency data is correctly flowing and correctly being displayed. In operation block 2217, the test results and pass or fail status is logged in the test logic database 309 for each service integration tested. In operation block 2219, the test logic 200 logs the error code along with any failed status, and the method of operation then terminates.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
simulating, by test logic, a public emergency network entity and a plurality of interfaces between the public emergency network entity and a test device;
monitoring, by the test logic, the plurality of interfaces to determine that data flowed correctly on each interface in response to an emergency alert sent from the test device such that the emergency alert is not actually sent to the public emergency network entity; and
determining, by the test logic, a test status for each interface indicating a success or failure of a test, for each interface, the test status based on data correctness such that the test confirms that the emergency alert and associated emergency data would be sent to the public emergency network entity correctly.

2. The method of claim 1, further comprising:
receiving the emergency alert sent from an alarm system where the alarm system is the test device.

3. The method of claim 2, further comprising:
receiving the emergency alert at a private emergency network entity that is performing a test on behalf of the public emergency network entity.

4. The method of claim 1, further comprising:
performing a geofence analysis of a location associated with the test device; and
executing the test only if the location is determined to be within a geofence associated with the public emergency network entity.

5. The method of claim 1, further comprising:
performing a geofence analysis of a location associated with the test device; and
preventing execution of the test if the location is determined to be outside a geofence associated with the public emergency network entity.

6. The method of claim 1, further comprising:
providing a simulated private emergency network entity graphical user interface (GUI) on a public emergency network entity; and
displaying an alert queue having an entry for the emergency alert as it would appear if sent to the public emergency network entity.

7. The method of claim 1, further comprising:
initiating, by the test logic, an emergency phone call from the test device, the test device having a location within a geofence of the public emergency network entity.

8. The method of claim 7, where initiating, by the test logic, the emergency phone call from a test device, comprises:
initiating, by the test logic, the emergency phone call as one of a voice-over-IP (VoIP) application phone call or a managed VoIP services phone call.

9. The method of claim 1, further comprising:
initiating, by the test logic, an emergency short-message-service (SMS) text message from the test device, the test device having a location within a call routing boundary of the public emergency network entity.

10. The method of claim 1, further comprising:
initiating, by the test logic, an emergency Internet Protocol Instant Message (IM) message from the test device, the test device having a location within a call routing boundary of the public emergency network entity.

11. The method of claim 1, further comprising:
sending, by the test logic, a plurality of representational state transfer (RESTful) hyper-text-transfer-protocol (HTTP) requests to a plurality of associated emergency network entities over the plurality of interfaces.

12. The method of claim 1, further comprising:
querying a Location Information Server (LIS) to obtain location information.

13. The method of claim 1, further comprising:
querying an Automatic Location Identification (ALI) database to obtain location information.

14. The method of claim 1, further comprising:
querying a Standard Master Street Address Guide (MSAG) to obtain location information.

15. The method of claim 1, further comprising:
querying an Emergency Services Zone Routing Database (ERDB) to verify that a location is within an emergency network call routing boundary.

16. Emergency network test logic, comprising:
an emergency network entity simulator, operative to: simulate a public emergency network entity and a plurality of interfaces between the public emergency network entity and a test device; and
manager logic, operatively coupled to the emergency network entity simulator, the manager logic operative to:
monitor the plurality of interfaces to determine that data flowed correctly on each interface in response to an emergency alert sent from the test device such that the emergency alert is not actually sent to the public emergency network entity; and
determine a test status for each interface indicating a success or a failure of a test, for each interface, the test status based on data correctness such that the test confirms that the emergency alert and associated emergency data would be sent to the public emergency network entity correctly.

17. The emergency network test logic of claim 16, further comprising:
front end logic, operatively coupled to the manager logic, the front end logic operative to provide a graphical user interface (GUI) simulating a GUI displayed on the public emergency network entity.

18. The emergency network test logic of claim 16, further comprising:
call flow logic, operatively coupled to the manager logic; and
wherein the manager logic is further operative to initiate an emergency phone call from a test device using the call flow logic, the test device having a location within a call routing boundary of the public emergency network entity.

19. The emergency network test logic of claim 18, wherein the manager logic is further operative to initiate the emergency phone call as one of a voice-over-IP (VoIP) application phone call or a managed VoIP services phone call.

20. Emergency network test logic, comprising:
front end logic, operative to provide a test graphical user interface (GUI) and a simulated GUI for a public emergency network entity, the front end logic operative to initiate testing procedures;
manager logic, operatively coupled to the front end logic, the manager logic operative to provide an asynchronous microservice that accepts Representational State Transfer (RESTful) HTTP requests, and to set up and trigger emergency network system tests in response to GUI input received from the front end logic; and
call flow logic, operatively coupled to the manager logic, operative to initiate an emergency call by a test device in response to commands received from the manager logic.
